(19) United States
(12) Patent Application Publication
(10) Pub. No.: US 2025/0081000 A1
(43) Pub. Date: Mar. 6, 2025

(54) COMMUNICATION METHOD, NETWORK NODE, ELECTRONIC DEVICE AND STORAGE MEDIUM

(71) Applicant: Samsung Electronics Co., Ltd., Suwon-si, Gyeonggi-do (KR)

(72) Inventors: Weiwei WANG, Beijing (CN); Hong WANG, Beijing (CN); Lixiang XU, Beijing (CN)

(21) Appl. No.: 18/726,699

(22) PCT Filed: Jan. 5, 2023
(86) PCT No.: PCT/KR2023/000244

§ 371 Date: Jul. 3, 2024

(30) Foreign Application Priority Data
Jan. 5, 2022 (CN) 202210006398.4
Sep. 30, 2022 (CN) 202211211202.1

(51) Int. Cl. H04W 24/02; H04W 68/02; H04W 76/20

(52) U.S. Cl. CPC H04W 24/02; H04W 68/02; H04W 76/20

(57) ABSTRACT

The disclosure relates to a 5G or 6G communication system for supporting a higher data transmission rate. Embodiments of the present invention provide a communication method and apparatus in a wireless communication system, an electronic device and a storage medium. The method can be executed by a first network node. The method includes receiving a first message including address information for data transmission with a second network node, and obtain the address information for the data transmission. wherein the address information for the data transmission includes address information of the first network node, and at least one address information corresponding to at least one network entity of a third network node.

### CROSS-REFERENCE TO RELATED APPLICATION(S)

This application is a U.S. National Stage application under 35 U.S.C. § 371 of an International application number PCT/KR2023/000244, filed on Jan. 5, 2023, which is based on and claims priority of a Chinese patent application number 202210006398.4, filed on Jan. 5, 2022, in the Chinese Patent Office, and of a Chinese patent application number 202211211202.1 filed on Sep. 30, 2022, in the Chinese Patent Office, the disclosure of each of which is incorporated by reference herein in its entirety.

### TECHNICAL FIELD

The present invention related to the communication field and in particular to a communication method, a network node, an electronic device and a storage medium.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In order to meet an increasing demand for wireless data communication services since a deployment of 4G communication system, efforts have been made to develop an improved 5G or pre-5G communication system. Therefore, the 5G or pre-5G communication system is also called “beyond 4G network” or “post LTE system”.

Wireless communication is one of the most successful innovations in modern history. Recently, a number of subscribers of wireless communication services has exceeded 5 billion, and it continues growing rapidly. With the increasing popularity of smart phones and other mobile data devices (such as tablet computers, notebook computers, notebooks, e-book readers and machine-type devices) in consumers and enterprises, a demand for wireless data services is growing rapidly. In order to meet rapid growth of mobile data services and support new applications and deployments, it is very important to improve efficiency and coverage of wireless interfaces.

### DISCLOSURE OF INVENTION

### Solution to Problem

To better satisfy practical application requirements, the embodiments of the present invention provide a communication method, a network node, an electronic device and a storage medium.

In accordance with an aspect of the disclosure, a method performed by a first network node a wireless communication system, the method comprising: receiving a first message including address information for data transmission with a second network node; and obtain the address information for the data transmission. wherein the address information for the data transmission includes address information of the first network node, and at least one address information corresponding to at least one network entity of a third network node.

In an embodiment, wherein the address information for data transmission further includes usage information indicating an usage of the address information of the first network node.

In an embodiment, wherein the receiving a first message comprises at least one of the following: receiving the first message from the third network node; and receiving the first message from the second network node, the first message is obtained by the second network node according to a second message received from the third network node.

In an embodiment, the method further comprising: transmitting a third message to the second network node according to the first message, the third message comprises the information about the address of the transmitted data.

In an embodiment, wherein the acquiring the address information for the data transmission comprises: receiving a fourth message from the second network node, and acquiring the address information for the data transmission according to the fourth message, the fourth message comprises information about determining the address information for the data transmission.

In an embodiment, wherein the fourth message is generated by the second network node according to at least one of: information about an address of data that is received from the third network node or the first network node; information for determining the address information of the data that is received from the third network node; and configuration information about the second network node.

In an embodiment, wherein the information for determining the address information of the data is determined by the third network node according to a fifth message received from the second network node, and the fifth message comprises at least one of: information about the network entity of the third network node; and configuration information about the second network node.

In accordance with an aspect of the disclosure, a method performed by a second network node a wireless communication system, the method comprising: obtaining address information for data transmission with a first network node; and performing data transmission with the first network node according to the address information for the data transmission. wherein the address information for the data transmission includes address information of the first network node, and at least one address information corresponding to at least one network entity of a third network node.

In an embodiment, the method further comprising: receiving a second message from the third network node, and wherein the address information for data transmission is obtained based on the second message.

In an embodiment, wherein the address information for data transmission further includes usage information indicating an usage of the address information of the first network node.

In accordance with an aspect of the disclosure, a first network node in a wireless communication system, wherein the first network node comprises: at least one transceiver; and at least one processor, the at least one processor is coupled to the transceiver and configured to: receive a first message including address information for data transmission with a second network node, and obtain the address information for the data transmission, wherein the address information for the data transmission includes address information of the first network node, and at least one address information corresponding to at least one network entity of a third network node.

In an embodiment, wherein the address information for data transmission further includes usage information indicating an usage of the address information of the first network node.

In accordance with an aspect of the disclosure, a second network node in a wireless communication system, wherein the second network node comprises: at least one transceiver; and at least one processor, the at least one processor is coupled to the transceiver and configured to: obtain address information for data transmission with a first network node; and perform data transmission with the first network node according to the address information for the data transmission; wherein the address information for the data transmission includes address information of the first network node, and at least one address information corresponding to at least one network entity of a third network node.

In an embodiment, the second network node according to claim 13, the method further comprising: receiving a second message from the third network node, and wherein the address information for data transmission is obtained based on the second message.

In an embodiment, wherein the address information for data transmission further includes usage information indicating an usage of the address information of the first network node.

In one aspect, an embodiment of the present invention provides a communication method in a wireless communication system, wherein the method may be executed by a first network node, and the method may include steps of:
receiving a first message, the first message includes information about an address of transmitted data, the address of the transmitted data is at least one address corresponding to a network entity of a third network node; and
acquiring the address information of the transmitted data, the address information of the transmitted data is address information of the first network node when the first network node performs data transmission with a second network node.

The address information of the first network node corresponds to the information about the address of the transmitted data. The address information of the first network node is the address information corresponding to at least one network entity of the third network node. In other words, the address information of the transmitted data is the address information of at least one of at least one address corresponding to the network entity of the third network node (the address information may include an address, or may include related information of the address, e.g., the usage of the address), and is an address selected from addresses corresponding to the information about the address of the transmitted data.

The first network node and the second network node may perform data transmission through the network entity of the third network node corresponding to the address information of the first network node.

The network entity of the third network node includes network entities managed (configured) by the third network node.

Optionally, the acquiring the address information of the transmitted data includes:
receiving a fourth message from the second network node, and acquiring the address information of the transmitted data according to the fourth message, the fourth message includes information about determining the address information of the transmitted data.

Optionally, the method further includes: transmitting a response message of the fourth message to the second network node.

In another aspect, an embodiment of the present invention provides a communication method in a wireless communication system, wherein the method is executed by a second network node, and the method includes steps of:
acquiring address information of transmitted data of a first network node; and
performing data transmission with the first network node according to the address information of the transmitted data;
wherein the address information of the transmitted data is address information of the first network node when the first network node performs data transmission with the second network node, and the address information of the transmitted data corresponds to at least one network entity of a third network node.

Optionally, before the acquiring address information of transmitted data of a first network node, the method further includes at least one of the following:
receiving a sixth message from the third network node or the first network node, the sixth message includes information about the address of the transmitted data;
transmitting a seventh message to the first network node, the seventh message includes the information about the address of the transmitted data.

Optionally, the information about the address of the transmitted data includes at least one of the following:
information about a transport layer address of the first network node; and, information about a network entity of the third network node corresponding to the transport layer address of the first network node.

Optionally, the acquiring address information of transmitted data of a first network node includes at least one of the following:
determining the address information of the transmitted data of the first network node according to the information about the address of the transmitted data that is received from the first network node or the third network node; and
acquiring the address information of the transmitted data of the first network node according to an eighth message received from the first network node or the third network node, the eighth message includes the information about determining the address information of the transmitted data.

Optionally, the method further includes at least one of the following:
transmitting a ninth message to the first network node, the ninth message includes information about determining the address information of the transmitted data;
receiving a response message of the ninth message transmitted by the first network node; and
transmitting a tenth message to the third network node, the tenth message includes at least one of the following:
information about the network entity of the third network node; and
configuration information about the second network node.

Optionally, the ninth message includes second information, and the second information indicates the address information of the transmitted data.

Optionally, the second information includes at least one of the information about the network entity of the third network node and the configuration information about the second network node, and the address information of the transmitted data corresponds to the network entity of the third network node.

Optionally, the ninth message includes indication information of the network entity of the third network node.

In another aspect, an embodiment of the present invention provides a communication method in a wireless communication system, wherein the method is executed by a third network node, and the method includes steps of:
transmitting an eleventh message to a first network node or a second network node, the eleventh message includes information about an address of transmitted data, the address of the transmitted data is at least one address corresponding to a network entity of a third network node.

The information about the address of the transmitted data is used for determining the address information of the transmitted data, and the address information is address information of the first network node when the first network node performs data transmission with the second network node.

Optionally, the information about the address of the transmitted data includes at least one of the following:
information about a transport layer address of the first network node; and, information about a network entity of the third network node corresponding to the transport layer address of the first network node.

Optionally, the method further includes: transmitting a twelfth message to the second network node, the twelfth message includes information about determining the address of the transmitted data.

Optionally, the twelfth message includes at least one of the following:
third information, the third information indicating the address information of the transmitted data; and
information about the network entity of the third network node.

Optionally, the method further includes at least one of the following:
receiving a thirteenth message from the second network node, the thirteenth message includes at least one of the information about the network entity of the third network node and the configuration information about the second network node;
receiving a fourteenth message from the second network node, the fourteenth message includes related information of the address information of the transmitted data; and
transmitting a response message of the fourteenth message to the second network node.

In another aspect, an embodiment of the present invention provides a network node in a wireless communication node, wherein the network node includes:
at least one transceiver; and
at least one processor, the at least one processor is coupled to the transceiver and configured to execute the communication method provided in any one of optional embodiments of the present invention.

In another aspect, an embodiment of the present invention provides a network node in a wireless communication system, wherein the network node includes a first information processing module configured to:
receive a first message, the first message comprises information about an address of transmitted data, the address of the transmitted data is at least one address corresponding to a network entity of a third network node; and
acquire the address information of the transmitted data, the address information of the transmitted data is the address information of the first network node when the first network node performs data transmission with a second network node.

The address information of the transmitted data corresponds to the information about the address of the transmitted data. That is, the address information of the transmitted data is selected on the basis of the information about the address of the transmitted data.

In another aspect, an embodiment of the present invention provides a network node in a wireless communication system, wherein the network node includes a second information processing module configured to:
acquire address information of transmitted data of a first network node; and
perform data transmission with the first network node according to the address information of the transmitted data;
wherein the address information of the transmitted data is address information of the first network node when the first network node performs data transmission with a second network node, and the address information of the transmitted data corresponds to a network entity of a third network node.

In another aspect, an embodiment of the present invention provides a network node in a wireless communication system, wherein the network node includes a third information processing module configured to:
transmit an eleventh message to a first network node or a second network node, the eleventh message includes information about an address of transmitted data, the address of the transmitted data is at least one address corresponding to a network entity of a third network node.

Optionally, the first network node is a relay node.

Optionally, the second network node is a base station (e.g., an anchor node), a central unit of the base station, or a control plane portion of the central unit of the base station. Optionally, the third network node is a base station (e.g., an anchor node), a central unit of the base station, or a control plane portion of the central unit of the base station.

Optionally, the first network node is managed by the third network node, and the first network node may perform data transmission with the second network node.

In another aspect, an embodiment of the present invention provides a communication method, wherein the method is executed by a seventh node, and the method includes:
receiving downlink data of a user equipment (UE), the UE is in an inactive state; and
transmitting a first notification message to a sixth node, the first notification message is used for triggering the UE to start downlink data transmission or terminate small data transmission of the UE.

In another aspect, an embodiment of the present invention provides a communication method, wherein the method is executed by a sixth node, and the method includes:
receiving a first notification message transmitted by a seventh node, the first notification message is used for triggering a UE in an inactive state to start downlink data transmission or terminate small data transmission of the UE; and
in response to the first notification message, transmitting a second notification message to the UE, or transmitting a third notification message to an eighth node;
wherein the second notification message is used for indicating the UE to start downlink data transmission or terminate small data transmission, and the third notification message is used for notifying the eighth node of triggering the UE to start downlink data transmission or terminate small data transmission of the UE.

In another aspect, an embodiment of the present invention provides a communication method, wherein the method is executed by an eighth node, and the method includes:
receiving a third notification message transmitted by a seventh node, the third notification message is used for notifying the eighth node of triggering a UE in an inactive state to start downlink data transmission or terminate small data transmission of the UE; and
transmitting a fourth notification message to the UE, the fourth notification message is used for indicating the UE to start downlink data transmission or terminate small data transmission.

In another aspect, an embodiment of the present invention provides a communication method, wherein the method is executed by a UE, the UE is in an inactive state, and the method includes:
receiving a notification message, the notification message is used for indicating the UE to start downlink data transmission or terminate small data transmission, the notification message is a second notification message received from a sixth node or a fourth notification message received from an eighth node; and
in response to the notification message, starting downlink data transmission or terminating small data transmission.

In another aspect, an embodiment of the present invention provides a network node in a wireless communication node, wherein the network node includes:
at least one transceiver; and
at least one processor, the at least one processor is coupled to the transceiver and configured to execute any one of the following:

the communication method executed by a sixth node provided by the present invention; the communication method executed by a seventh node provided by the present invention; and the communication method executed by an eighth node provided by the present invention.

In another aspect, an embodiment of the present invention provides a user equipment, wherein the user equipment includes:
at least one transceiver; and
at least one processor, the at least one processor is coupled to the transceiver and configured to execute the communication method executed by a UE provided by the present invention.

In another aspect, an embodiment of the present invention provides an electronic device, including a processor and a memory, wherein the memory stores computer programs, and the processor executes the computer programs stored in the memory to implement method provided in any one of optional embodiments of the present invention.

Optionally, the electronic device may be a first network node, a second network node or a third network node.

In another aspect, an embodiment of the present invention provides a computer-readable storage medium storing computer programs that, when executed by a processor, implement the method provided in any one of optional embodiments of the present invention.

In another aspect, an embodiment of the present invention provides a computer program product, including computer programs that, when executed by a processor, implement the method provided in any one optional embodiments of the present invention.

The technical solutions provided in the embodiments of the present invention have the following beneficial effects. In accordance with the communication method provided by the present invention, when a first network node and a second network node perform data transmission by using a network managed by a third network node, the configuration and selection of the address information of the first network node can be realized, so that the data transmitted between the first network node and the second network node can reach a destination receiving node, and the actual communication requirements can be better satisfied.

### BRIEF DESCRIPTION OF DRAWINGS

In order to explain the technical solutions in the embodiments of the present invention more clearly, the accompanying drawings to be used in the description of the embodiments of the present invention will be briefly illustrated below.

FIG. 1 is a schematic diagram of a system architecture to which an embodiment of the present invention is applicable;

FIG. 2 is a schematic diagram of a system architecture to which an embodiment of the present invention is applicable;

FIG. 3 is a schematic diagram of a base station to which an embodiment of the present invention is applicable;

FIG. 4 is a schematic architecture diagram of a relay network according to an embodiment of the present invention;

FIG. 5 is a schematic diagram of network structures in two communication scenarios according to an embodiment of the present invention;

FIG. 6 is a flowchart of a communication method according to an embodiment of the present invention;

FIG. 7 is a flowchart of a communication method according to an embodiment of the present invention;

FIGS. 8, 9, 10, 11, 12, 13, 14, 15 and 16 are flowcharts of communication methods according to various alternative implementations of the present invention;

FIGS. 17a and 17b are flowcharts of two optional communication methods according to the present invention; and

FIG. 18 is a schematic structure diagram of an electronic device to which the present invention is applicable.

### MODE FOR INVENTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the present disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

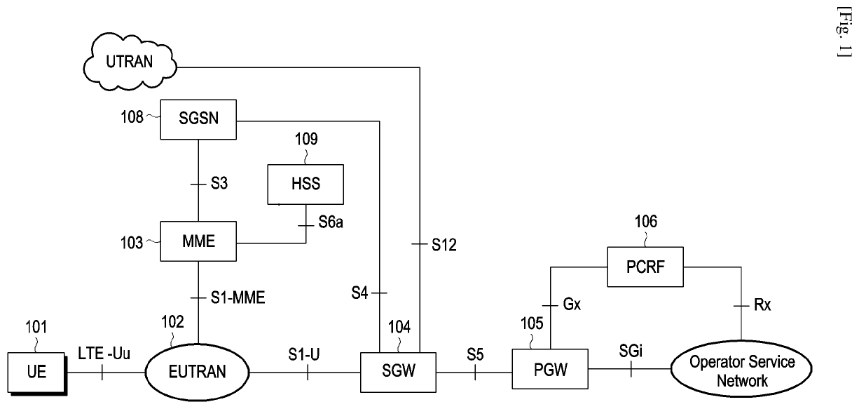

FIGS. 1 to 17 discussed below and various embodiments for describing the principles of the present disclosure in this patent document are only for illustration and should not be interpreted as limiting the scope of the disclosure in any way. Those skilled in the art will understand that the principles of the present disclosure can be implemented in any suitably arranged system or device.

FIG. 1 is an exemplary system architecture 100 of system architecture evolution (SAE). User equipment (UE) 101 is a terminal device for receiving data. An evolved universal terrestrial radio access network (E-UTRAN) 102 is a radio access network, which includes a macro base station (eNodeB/NodeB) that provides UE with interfaces to access the radio network. A mobility management entity (MME) 103 is responsible for managing mobility context, session context and security information of the UE. A serving gateway (SGW) 104 mainly provides functions of user plane, and the MME 103 and the SGW 104 may be in the same physical entity. A packet data network gateway (PGW) 105 is responsible for functions of charging, lawful interception, etc., and may be in the same physical entity as the SGW 104. A policy and charging rules function entity (PCRF) 106 provides quality of service (QoS) policies and charging criteria. A general packet radio service support node (SGSN) 108 is a network node device that provides routing for data transmission in a universal mobile telecommunication system (UMTS). A home subscriber server (HSS) 109 is a home subsystem of the UE, and is responsible for protecting user information including a current location of the user equipment, an address of a serving node, user security information, and packet data context of the user equipment, etc.

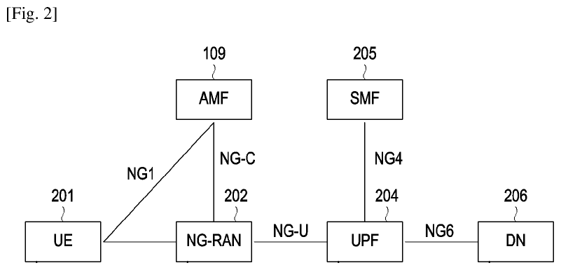

FIG. 2 is an exemplary system architecture 200 according to various embodiments of the present disclosure. Other embodiments of the system architecture 200 can be used without departing from the scope of the present disclosure.

User equipment (UE) 201 is a terminal device for receiving data. A next generation radio access network (NG-RAN) 202 is a radio access network, which includes a base station (a gNB or an eNB connected to 5G core network 5GC, and the eNB connected to the 5GC is also called ng-gNB) that provides UE with interfaces to access the radio network. An access control and mobility management function entity (AMF) 203 is responsible for managing mobility context and security information of the UE. A user plane function entity (UPF) 204 mainly provides functions of user plane. A session management function entity SMF 205 is responsible for session management. A data network (DN) 206 includes, for example, services of operators, access of Internet and service of third parties.

In a new radio (NR) access system, in order to support network function virtualization and more efficient resource management and scheduling, the base station (gNB/ng-eNB) that provides the terminal (UE) with a radio network interface may be subdivided into a gNB central unit/ng-eNB central unit (gNB-CU/ng-eNB-CU, referred to as CU herein for short) and a gNB distributed unit/ng-eNB distributed unit (gNB-DU/ng-eNB-DU, referred to as DU herein for short), as shown in FIG. 3(a). The gNB-CU has a radio resource control (RRC) layer, a service data adaptation protocol (SDAP) layer, a packet data convergence protocol (PDCP) layer, etc., and the ng-eNB-CU has an RRC layer and a PDCP layer. The gNB-DU/ng-eNB-DU has a radio link control (RLC) protocol layer, a medium access control (MAC) layer, a physical layer, etc.

There is a standardized public interface F1 (F1 interface) between the gNB-CU and the gNB-DU, and there is a standardized public interface W1 (W1 interface) between the ng-eNB-CU and the ng-eNB-DU. The F1 interface includes a control plane F1-C and a user plane F1-U. The transport network layer of the F1-C is based on IP transmission. To realize more reliable transmission signaling, a stream control transmission protocol (SCTP) is additionally provided on the IP. The protocol for the application layer is F1AP, see 3GPP TS38.473. The SCTP may provide reliable transmission of application layer messages. The transport layer of the F1-U is UDP/IP, and the GTP-U is used on the UDP/IP to bear protocol data units (PDUs) of the user plane. Further, for the gNB-CU, as shown in FIG. 3(b), the gNB-CU may include a gNB-CU-CP (the control plane portion of the central unit of the base station) and a gNB-CU-UP (the user plane portion of the central unit of the base station). The gNB-CU-CP includes the function of the control plane of the base station, and has a RRC layer and a PDCP layer. The gNB-CU-UP includes the function of the user plane of the base station, and has a service data adaptation protocol (SDAP) layer and a PDCO layer. There is a standardized public interface E1 (E1 interface) between the gNB-CU-CP and the gNB-CU-UP, and the protocol is E1AP, see 3GPP TS38.463. The interface between the control plane portion of the central unit of the base station and the distributed unit of the base station is an F1-C interface, i.e., a control plane interface of the F1; and, the interface between the user plane portion of the central unit of the base station and the distributed unit of the base station is an F1-U interface, i.e., a user plane interface of the F1.

In addition, in the NR system, the base station that accesses the 5G core network and provides the E-UTRA user plane and control plane is called an ng-eNB. In order to support virtualization, this base station (ng-eNB) may be subdivided into a gNB central unit/ng-eNB central unit (ng-eNB-CU, referred to as CU herein for short) and a gNB distributed unit/ng-eNB distributed unit (ng-eNB-DU, referred to as DU herein for short), as shown in FIG. 3(c). The ng-eNB-CU has an RRC layer and a PDCP layer. The gNB-DU/ng-eNB-DU has a radio link control (RLC) protocol layer, a medium access control (MAC) layer, and a physical layer, etc. There is a standardized public interface W1 between the ng-eNB-CU and the ng-eNB-DU. The W1 interface includes a control plane W1-C and a user plane W1-U. The transport network layer of the W1-C is based on IP transmission. To realize more reliable transmission signaling, an SCTP is additionally provided on the basis of the IP. The protocol for the application layer is W1AP, see 3GPP TS37.473. The transport layer of the W1-U is UDP/IP, and the general packet radio service tunnel protocol user (GTP-U) is used on the UDP/IP to bear PDUs of the user plane.

In the NR network, in order to expand the coverage of the network, a relay network architecture (i.e., integrated access and backhaul, IAB) is provided. A donor/anchor node and a relay node (e.g., IAB node) are introduced in the architecture. The anchor node may be a separate base station, or may be a base station consisting of an IAB-donor central unit and an IAB-donor distributed unit. The relay node has a mobile terminal function and a distributed terminal function. In another example, the relay node may be described as including a mobile terminal (MT) portion and a distributed unit (DU) portion, wherein the mobile terminal function is used to communicate with an upper-level node of the relay node, the DU portion is used to communicate with a next-level node of the relay node, and a connection is established between the DU portion and the anchor node to service a user accessing the DU portion. The network including the IAB node is a relay network. In order to further expand the coverage of the network, the mobility of the relay node has been taken into consideration in the current researches. For example, a delay node is deployed on a vehicle, so that the relay node provides services for the user of this vehicle.

FIG. 4 shows a schematic architecture of a multi-hop relay network (IAB network). A network architecture including an anchor node (e.g., IAB donor/anchor) and two relay nodes (i.e., IAB nodes) is shown. Users in the multi-hop network can access the network through the anchor node or the distributed unit of the anchor node or the relay nodes. For example, a user 1, a user 2 and a user 3 (i.e., UEs) access the relay network through the distributed unit of the anchor node, the distributed unit portion of the relay node 1 and the distributed unit portion of the relay node 2, respectively. The mobile terminal function (the mobile terminal portion) of the relay node is used to communicate with an upper-level node of this relay node (for example, the mobile terminal portion of the relay node 1 is used to communicate with the anchor node or the distributed unit of the anchor node, and the mobile terminal portion of the relay node 2 is used to communicate with the distributed unit portion of the relay node 1). The distributed unit portion of the relay node is used to communicate with a next-level node of this relay node (for example, the distributed unit portion of the relay node 1 is used to communicate with the user 2, or may be used to communicate with the mobile terminal portion of the relay node 2). The mobile terminal portion of the relay node may be regarded as a user accessing the network, so this mobile terminal portion has the function of an ordinary user (a non-relay node) (for example, the mobile terminal portion may establish a signaling radio bearer (SRB) with its upper-level node to transmit an RRC message, or may establish a data radio bearer (DRB) to transmit data).

The protocol stack included in the central unit of the anchor node includes a protocol stack serving the control plane and a protocol stack serving the user plane, wherein the protocol stack serving the control plane includes an RRC protocol layer and a PDCP layer, and the protocol stack serving the user plane includes an SDAP layer and a PDCP layer. The protocol stack included in the distributed unit of the anchor node or the distributed unit portion of the relay node includes: protocol stacks serving the control plane and the user plane, each of the protocol stack includes an RLC protocol layer, an MAC protocol layer and a physical (PHY) layer. The interfaces between the central unit of the anchor point and the distributed unit of the anchor node and between the central unit of the anchor node and the distributed unit of the relay node are F1 interfaces (see 3GPP TS38. 473).

In the relay network, the link between the relay node and the anchor node or the distributed unit of the anchor node or between the relay nodes is a backhaul link. One or more different backhaul channels (e.g., the backhaul link channel 1 and the backhaul link channel 2 shown in FIG. 4) will be established on the backhaul link. An example of the backhaul link channel is a backhaul radio link control (RLC) channel. In the relay network, each backhaul link channel will be used to transmit data packets belonging to the same user or different users. The data packet may be a data packet of the user data radio bearer (DRB), or a data packet of the user signaling radio bearer (SRB), or a data packet of the control plane on the F1 interface, or a data packet of the user plane on the F1 interface, or a data packet of the non-F1 interface (e.g., an Internet security protocol (IPSec) data packet, a data packet of the SCTP, a data packet of the operation administration and maintenance (OAM), etc.).

In order to realize the transmission of user data in the multi-hop relay network, a new protocol layer (i.e., a backhaul adaptation protocol (BAP) layer) is defined in 3GPP. This protocol layer will be configured in the distributed unit of the anchor node and the anchor node (e.g., in the mobile terminal portion of the relay node and/or the distributed unit portion of the relay node), and is located above the RLC layer. The main function of the protocol layer is to route and map data packets. In order to transmit user data between the relay node and the anchor node, it is necessary to complete the configuration of the backhaul link and the configuration of the F1 interface between the distributed unit portion of the relay node and the anchor node. These configurations include, but not limited to, the following types, for example, the BAP address, the route configuration (e.g., route identifier information, where this information indicates different transmitting routes, and this information includes the BAR address and route identifier of the destination receiving node), the configuration of the backhaul link channel, the configuration of the tunnel, the backhaul link configuration for the tunnel, etc.

In the relay network, the transmission of the user data needs to be transmitted through the IP layer between the relay node and the anchor node. The data packet transmitted to the relay node needs to be transmitted to the anchor node (or the distributed unit of the anchor node) accessed by the relay node, so the IP address of the data packet needs to be set to ensure that, during routing in the wired network, the data packet can be firstly routed to the anchor node (or the distributed unit of the anchor node) and then transmitted to the final destination receiving node (e.g., the destination relay node, the anchor node) by the wireless link in the relay network. During this process, the relay node needs to configure the correct address.

In addition, in the relay network or the non-relay network, some users will be in an inactive state (also referred to as an inactive status, a non-active state, etc.). If these users need to transmit data, they need to enter a connected state first and then perform data transmission. However, the users enter the connected state to transmit some relatively small data (referred to as small data in the present invention), such as data in relatively small data packets or data that is not transmitted frequently. As a result, the signaling overhead caused by the user entering the connected state is larger than the data to be transmitted by the user. In order to reduce the signaling overhead of small data transmission by the user, a mechanism of small data transmission has been proposed in the 3GPP, that is, the user may perform small data transmission in the inactive state without entering the connected state.

The technical solutions in the embodiments of the present invention and the technical effects achieved by the technical solutions of the present invention will be explained below by describing several exemplary implementations. It is to be pointed out that the text and the accompanying drawings are provided by way of example to facilitate the understanding of the present disclosure. They should not be construed as limiting the scope of the present disclosure in any way. The following implementations may refer to or learn from each other or be combined with each other, and the same terms, similar features and similar implementation steps in different implementations will not be repeated. Although some embodiments and examples have been provided, based on the contents disclosed herein, it is obvious to those skilled in the art that alterations may be made to the illustrated embodiments and examples without departing from the scope of the present disclosure.

Before the introduction of the specific contents, some assumptions and some definitions of the present invention will be provided below.
The message names or information names in the present invention are only examples, and other message names or other information names may be used. The message or information names do not constitute any restrictive explanations to the solutions of the present invention.
The “first”, “second”, etc. included in the message names of the present invention are only examples of messages, and do not represent the execution order.
The detailed description of steps irrelevant to the present invention is omitted in the embodiments of the present invention.
In the present invention, the steps in each process may be executed in combination or independently. The execution steps of each process are only examples, and other possible execution orders are not excluded.
The base station in the present invention may be a 5G base station (e.g., gNB, ng-eNB), or may be a 4G base station (e.g., eNB), or may be other types of access nodes.
In the present invention, the transmission of data refers to receiving or transmitting data.
In the present invention, the uplink data refers to the data transmitted from a relay node to a base station (an anchor node), and the downlink data refers to the data transmitted from a base station (an anchor node) to a relay node.
In the present invention, the transmitted data refers to the information transmitted between different nodes, and the transmitted data may also be known as data, data traffic, data packet, datagram, message or other names. The transmitted data may be any type of data. For example, the transmitted data may be user plane data, non-user plane data, control plane data or signaling, etc.
In the present invention, the structure of the relay node referred in the description of the solutions includes a mobile terminal portion and a distributed unit portion, and the interface between the distributed unit portion of the relay node and the anchor node (or the central unit portion of the anchor node) is an F1 interface. However, the solutions of the present invention are also applicable to relay nodes of other structures. In one embodiment, another possible structure of the relay node includes a mobile terminal portion and a base station portion, and the interface between the base station portion and the anchor node (or the central unit portion of the anchor node) is an Xn/X2 interface.

The nodes involved in the present invention are described below.
First node: It is a relay node. This node includes two portions, wherein the first portion is used for the relay node to access the network and called a first entity of the first node, and the second portion is used to serve the user and called a second entity of the first node. In one example, if this relay node is an IAB node i.e., including an MT portion and a DU portion, the first entity of the first node is the MT portion and the second entity of the first node is the DU portion. In another embodiment, if this relay node is a node with a base station function, for example, including an MT portion and a base station portion, the first entity of the first node is the MT portion and the second entity of the first node is the base station portion.
Second node: It is a base station, or a central unit of the base station, or a control plane portion of the central unit of the base station. The base station specific to the second node is a node connected to the first node. In one embodiment, the second node is a node that establishes an RRC connection with the first node (or the first entity of the first node). In another embodiment, the second node is a node that establishes an interface (e.g., an F1 interface, an Xn/X2 interface) with the first node (the second entity of the first node). In still another embodiment, the second node is a node that establishes an interface and an RRC connection with the first node. Specifically, the second node may be an anchor node of the first node, or may be a node with an anchor node function.
Third node: It is a base station, or a central unit of the base station, or a control plane portion of the central unit of the base station. The base station specific to the third node is a node connected to the first node. In one embodiment, the third node is a node that establishes an RRC connection with the first node (or the first entity of the first node). In another embodiment, the third node is a node that establishes an interface (e.g., an F1 interface, an Xn/X2 interface) with the first node (the second entity of the first node). In still another embodiment, the third node is a node that establishes an interface and an RRC connection with the first node. Specifically, the third node may be an anchor node of the first node, or may be a node with an anchor node function.
Fourth node: It is a relay node. This node includes two portions, wherein the first portion is used for the relay node to access the network and called a first entity of the fourth node, and the second portion is used to serve the user and called a second entity of the fourth node. In one example, if this relay node is an IAB node i.e., including an MT portion and a DU portion, the first entity of the fourth node is the MT portion and the second entity of the fourth node is the DU portion. In another embodiment, if this relay node is a node with a base station function, for example, including an MT portion and a base station portion, the first entity of the fourth node is the MT portion and the second entity of the fourth node is the base station portion. In one embodiment, the fourth node is a child node of the first node, that is, the fourth node accesses the network through the first node. For example, the fourth node (or the first entity of the fourth node) establishes an RRC connection with the second node through the first node, and the first node is an intermediate node between the fourth node and the second node. In the network structure shown in FIG. 4, the first node may be the relay node 1, and the fourth node may be the relay node 2.

In the following description of some embodiments of the present invention, the description is provided by taking the first node being an IAB node, and the interface established by the second entity of the first node is an F1 interface. However, the solutions described in the present invention are applicable to other types of relay nodes, and the following description of the F1 interface is also applicable to other types of interfaces established between the second entity of the first node and the second node/the third node.

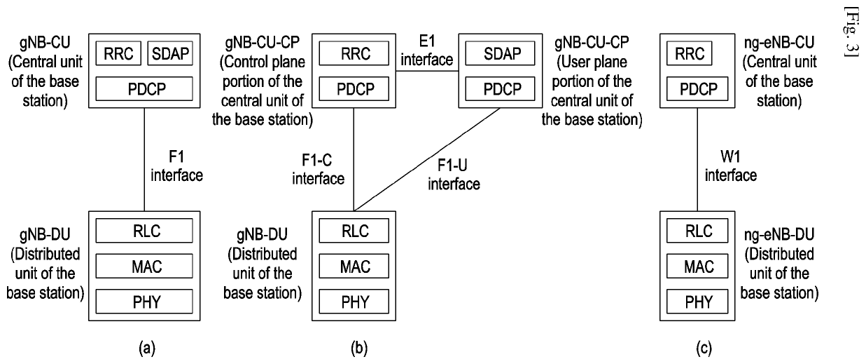

In order to better understand and describe the solutions provided in the present invention, two scenarios to which the present invention is applicable will be described below with reference to FIG. 5.

### Scenario 1: Dual-Connection Scenario

FIG. 5(a) shows a schematic network architecture in this scenario. The first node (or the mobile terminal portion of the first node) establishes a dual connection with the second node and the third node, and the first node may be directly or indirectly connected to the second node or the third node. In other words, optionally, there may be one or more intermediate nodes between the first node and the second node (for illustration, only one intermediate node (i.e., a fifth node) is shown, and this node may be a relay node or a distributed unit of a base station), and there may be one or more intermediate nodes between the first node and the third node (for illustration, only one intermediate node (i.e., a sixth node) is shown, and this node may be a relay node or a distributed unit of a base station). In addition, the first node may also have one or more child nodes that are directly or indirectly connected thereto (for illustration, only one child node is shown, and this child node is described by taking a fourth node as an example). The data of the first node (or the distributed unit portion of the first node) and/or the fourth node (or the distributed unit portion of the fourth node) may be transmitted through two different paths. One path is a path which is served by the network managed by the first node. In the schematic diagram of FIG. 5(a), the network includes a fifth node. In an actual system, the network between the first node and the second node has one or more different nodes, and this network is managed by the first node (it should be understood that the nodes in this network are configured and managed by the first node). The other path is a path which is served by the network managed by the third node. In the schematic diagram of FIG. 5(a), the network includes a sixth node. In an actual system, the network between the first node and the third node has one or more different nodes, and this network is managed by the third node. If the third node is the central unit of the base station but does not establish an interface (e.g., F1 interface) with the first node, the data of this path will not pass through the third node (since the transmitting of the user data needs to be transmitted through the IP layer between the relay node and the anchor node, the data packet transmitted to the relay node needs to be firstly transmitted to the anchor node or the distributed unit of the anchor node accessed by the relay node).

### Scenario 2: Single-Connection Scenario

As shown in FIG. 5(b), the first node (or the mobile terminal portion of the first node) establishes a single connection with the third node, and the first node (or the distributed unit portion of the first node) establishes an interface (e.g., an F1 interface) with the second node. Optionally, there may be one or more intermediate nodes between the first node and the third node (for illustration, only one intermediate node (i.e., a sixth node) is shown, and this node may be a relay node or may be a distributed unit of a base station). In this scenario, the data on the interface between the first node (or the distributed unit of the first node) and/or the fourth node (or the distributed unit of the fourth node) and the second node will be transmitted through only one path. That is, this path belongs to the network managed by the third node. In the schematic diagram of FIG. 5(b), this network includes a sixth node. In an actual system, the network between the first node and the third node may have one or more different nodes, and this network is managed by the third node. If the third node is the central unit of the base station, the data of this path will not pass through the third node.

In the relay network, when the distributed unit portion of one relay node performs data transmission with the central unit (which may include a control plane portion and a user plane portion) of the anchor node connected thereto, it is necessary to use an IP layer protocol. Therefore, the distributed unit portion of the relay node needs to have an IP address. In order to ensure the correct arrival of the data packet of the relay node (the data packet received or transmitted by the relay node), the used IP address is associated with the distributed unit of the anchor node passed by these IPs. That is, if the data packet reaches the relay node through the distributed unit of a particular anchor node, the relay node needs to use the IP address corresponding to the distributed unit of this anchor node. Under such circumstances, the following problems will occur in the above scenarios.

When the data packet of the relay node (e.g., the first node and/or the fourth node) is transmitted through the network managed by the third node, the distributed unit of the anchor node (e.g., the sixth node in FIG. 5) passed by the data packet is controlled (managed) by the third node. However, since the IP address used by the relay node is determined by the relay node, the IP address selected by the relay node is possibly not associated with the distributed unit of the anchor node determined by the third node, so that the data cannot reach the specified relay node.

In order to overcome the above problems and ensure that the data packet can be correctly transmitted to the destination receiving node, an embodiment of the present invention provides a communication method. In order to better describe and understand the contents of the embodiments of the present invention, several schematic node names will be provided in the following description of embodiments.

First network node: This node is a relay node. Optionally, this node may be the first node described above, or may be a child node of the first node. The child node of the first node may be a network node directly connected to the first node, or may be a network node indirectly connected to the first node. The following description will be provided by taking the fourth node being used as the child node of the first node as an example.

Second network node: This node may be a base station, or a central unit of the base station, or a control plane portion of the central unit of the base station. Optionally, the second network node may be the second node described above.

Third network node: This node may be a base station, or a central unit of the base station, or a control plane portion of the central unit of the base station. Optionally, the second network node may be the third node described above.

The alternative implementations of the present invention will be further described below in detail with reference to the accompanying drawings.

FIG. 6 shows a flowchart of a communication method according to an embodiment of the present invention. This method may be executed by the first network node. In accordance with this method, the related configuration of the address information available for the first node can be realized when the first network node and the second network node perform data transmission via the network entity of the third network node. Optionally, the address information used by the first network node can also be determined. As shown in FIG. 6, the method may include the following steps.

At S610, a first message is received, the first message includes information about an address of transmitted data, the address of the transmitted data is at least one address corresponding to the network entity of the third network node.

Optionally, if the first network node and the second network node perform data transmission through the network entity of the third network node, the method may further include the following steps.

At S620, address information of the transmitted data is acquired, the address information of the transmitted data is address information of the first network node when the first network node performs data transmission with the second network node, the address information corresponding to the information about the address of the transmitted data.

The first message may also be referred to as a configuration message, and is used to configure the information about the address of the first network node. The address of the transmitted data corresponding to the network entity of the third network node means that the information about the address of the transmitted data included in the first message is the related information of the address corresponding to the network entity of the third network node. Optionally, the network entity of the third network node may be at least one distributed unit of the anchor node (the anchor node corresponding to the first network node), and the information about the address of the transmitted data includes the related information of the address associated with the at least one distributed unit.

When data transmission is performed between the first network node and the second network node, if the network entity passed by the data packet is managed by the third node, in order to ensure the correct transmission of the data packet, the address (e.g., transport layer address/IP address) used by the first network node should be the address corresponding to the network entity of the third network node. On this basis, the information about the address of the transmitted data may be configured for the first network node by the third network node. When data transmission is performed between the first network node and the second network node by using the network entity of the third network node, the address information corresponding to the first network node may be selected according to the configuration information of the third network node. That is, at this time, the address for data transmission used by the first network node is the address associated with the network entity of the third network node.

It should be understood that the information about the address of the transmitted data includes the related information of the address for data transmission with the second network node. When the first network node and the second network node perform data transmission by using the network entity of the third network node (e.g., the distributed unit of the anchor node), the address of the first network node is at least one of addresses corresponding to the information about the address of the transmitted data. That is, the address information of the first network node is selected/determined according to the information about the address of the transmitted data. It is to be noted that, in an actual implementation, the first message incudes optional information about at least one address available for data transmission, and the information is used to assist in determining the address information for data transmission between the first network node and the second network node. However, at this time, the information about at least one address actually does not indicate that the information about which address(es) is the related information of the address for data transmission between the first network node and the second network node, but the address for data transmission with the second network node can be determined from the addresses corresponding to the information according to the information about the address of the transmitted data.

The address information of the transmitted data may include the address (e.g., IP address or BAP address) of the transmitted data, or may include the related information of the address of the transmitted data, for example, the index of the address or the usage of the address (i.e., the address is an address for what purpose), etc.

Optionally, the information about the address of the transmitted data may include at least one of the following:
information about a transport layer address of the first network node; and
information about a network entity of the third network node corresponding to the transport layer address of the first network node.

It should be understood that the information about the address of the transmitted data may include information about one or more addresses.

The information about the transport layer address of the first network node may assist in configuring the address information of the first network node (i.e., addresses available for the first network node, possibly including the usage of available addresses, etc.). For example, the information may include at least one of the following:
at least one of addresses such as IP addresses or BAP addresses;
index information of addresses such as IP addresses or BAP addresses; and
an usage indication of at least one address, for example, which may include information indicating that the IP address is used for transmitting user plane data or transmitting control plane signaling, etc.

The information about the network entity of the third network node corresponding to the transport layer address of the first network node may inform the address information of the network entity associated with the configured address information of the first network node, for example, at least one of the addresses such as IP addresses or BAP addresses of the distributed unit. The network entity of the third network node may include, but not limited to, at least one of the distributed unit of the anchor node where the first network node is anchored or the distributed unit of the anchor node where the first network node performs data transmission.

In one optional embodiment of the present invention, the first network node receiving a first message may include at least one of the following:
receiving a first message from the third network node; and
receiving a first message from the second network node, the first message is obtained by the second network node according to a second message received from the third network node.

In other words, the first message may be transmitted to the first network node by the second network node or may be transmitted to the first network node by the third network node. However, regardless of the first message being transmitted by the second network node or by the third network node, the configuration included in the first message (i.e., the information about the address of the transmitted data, which may use other information names) is configured by the third network node. Optionally, it is possible that the second message (including the information about the address of the transmitted data) is transmitted to the second network node by the third network node and the first message is then transmitted to the first network node by the second network node.

It is to be noted that the configuration information of the first network node, included in both the first message and the second message, may be identical or at least partially identical. When the configuration information of the first network node acquired from the third network node is forwarded to the first network node by the second network node, the configuration information may be transparently transmitted to the first network node by the second network node, that is, the second network node cannot acquire the configuration information. The configuration information may also be transmitted non-transparently and forwarded to the first network node by the second network node. In this way, the second network node can also know the configuration information.

In one optional embodiment of the present invention, the method may further include:
transmitting a third message to the second network node according to the first message, the third message includes the information about the address of the transmitted data.

It can be known from the above description that the configuration information included in the first message may be transmitted to the first network node by the third network node or may be transparently transmitted to the first network node by the second network node. In the two modes, the second network node cannot acquire the configuration information of the first network node. Therefore, upon acquiring the configuration information, the first network node may transmit a corresponding third message to the second network node, so that the second network node can know the information about the address of the transmitted data corresponding to the network entity of the third network node. Thus, the second network node may select the address information of the first network node according to the related information included in the third message, or the second network node may be assisted in performing corresponding configuration when it performs data transmission through the network entity of the third network node, for example, configuring the data transmitted through the network entity of the third network node.

Similarly, the configuration information of the first network node included in both the third message and the first message may be identical or at least partially identical. The names of the first message, the second message and the third message will not be limited in the present invention, and one or more of the first message, the second message and the third message may be the existing message in the existing communication standard or a newly defined message.

In accordance with the above optional embodiments, the related configuration of the third network node with respect to the first network node is realized, and at least one of the first network node and/or the second network node may acquire the related configuration of the address information of the first network node (which may be understood as the related information of addresses selectable by the first network node) according to the related configuration. Optionally, the address used when the first network node performs data transmission with the second network node and the related information thereof may be selected/determined on the basis of the related configuration. Since the address corresponding to the related configuration is the address corresponding to the network entity of the third network node, determining the address used by the first network node means that the network entity of the third network used when the first network node performs data transmission with the second network node and the address information of the first network node corresponding to such network entity are determined. The optional implementation of acquiring the address information of the transmitted data (i.e., the address information for data transmission between the first network node and the second network node) will be described below.

In one optional embodiment of the present invention, the acquiring the address information of the transmitted data includes:
receiving a fourth message from the second network node, and acquiring the address information of the transmitted data according to the fourth message, the fourth message includes information about determining the address information of the transmitted data.

Optionally, the method may further include: transmitting a response message of the fourth message to the second network node.

Optionally, the information about determining the address information of the transmitted data may be indication information of the address information, or may be information for assisting the first network node in determining the address information. In other words, the address information of the transmitted data may be determined by the first network node itself, or may be determined by the second network node or the third network node. When the address information is determined by the second network node or the third network node, the indication of the determined address information may be transmitted to the first network node by the second network node (if the address information is determined by the third network node, the third network node may transmit the related information to the first network node through the second network node), wherein the indication may be an explicit indication or an implicit indication. The first network node may obtain, according to the indication information, the address information used when performing data transmission with the second network node.

In an optional mode, the fourth message includes first information, and the first information indicates the address information of the transmitted data. In this mode, the address information of the transmitted data indicated by the first information may be determined by the second network node, or may be determined by the third network node. The first network node may acquire the address information of the transmitted data according to the first information.

In another optional mode, the fourth message may include assistant information, and the assistant information is used to assist the first network node in determining the address information of the transmitted data. In this mode, the first network node acquiring the address information of the transmitted data according to the fourth message may include:
determining the address information of the transmitted data according to the first message and the fourth message.

In this optional mode, the assistant information included in the fourth message may include at least one of the following:
information about the network entity of the third network node, the address information of the transmitted data corresponding to the network entity of the third network node; and
configuration information about the second network node.

The information about the network entity of the third network node may allow the first network node to know that the network entity corresponding to the address information of the transmitted data is which entity, for example, the address corresponding to which distributed unit. Based on this information, the first network node may select appropriate address information of the transmitted data according to the information about the address corresponding to the network entity in the first message. The information about the network entity of the third network node may be determined by the second network node according to the acquired information about the address of the transmitted data (i.e., the configuration information of the first network node), or may be determined by the third network node, then notified to the second network node and transmitted to the first network node by the second network node through the fourth message according to the related information acquired from the third network node. In other words, the used network entity of the third network node may be determined by the second network node or the third network node.

The configuration information (which may use other information names) about the second network node is used to provide the first network node with the configuration information on the second network node side, to assist the first network node in selecting appropriate address information of the transmitted data. Optionally, the configuration information may include related configuration information of the second network node when performing data transmission with the first network node, for example, related information of a bearer (at least one of a data bearer or a signaling bearer), information about the transmitted data. For example, the configuration information may include the address information (e.g., IP address) of the second network node. The address information may indicate the address where the second network node receives uplink data, or may be indication information of the data type. The information may indicate the type of the data to be transmitted. Optionally, the configuration information about the second network node may include some or all of the configuration information about the base station provided by the base station (or the central unit of the base station or the control plane portion of the central unit of the base station) to its managed network node in the existing communication mode.

It can be seen from the above optional embodiments that the address information used by the first network node (i.e., the address information of the transmitted data) may be determined by the first network node, the second network node or the third network node, and the network entity of the third network node corresponding to the address information may be determined by the second network node or the third network node. The first network node may directly acquire the address information of the transmitted data according to the fourth message received from the second network node, or may determine the address information of the transmitted data by itself according to the configuration information included in the first message and the fourth message. Optionally, the fourth message may be determined by the second network node according to at least one of the following:
information about the address of the transmitted data that is received from the third network node or the first network node;
information about determining the address information of the transmitted data that is received from the third network node; and
configuration information about the second network node.

The information about the address information of the transmitted data that is received from the third network node or the first network node is the configuration information of the first network node configured for the first network node by the third network node. The second network node may determine the address information of the transmitted data of the first network node or the network entity of the third network node according to the configuration information, and provides the first network node with the determined related information through the fourth message.

The information about determining the address information of the transmitted data that is received from the third network node may be indication information of the address information of the transmitted data of the first network node (that is, the address of the transmitted data of the first network node may be determined by the third network node), or may be the related information of the network entity of the third network node (that is, the network entity corresponding to the address information of the transmitted data of the first network node may be determined by the third network node).

The configuration information about the second network node may be used to assist the second network node in determining the information in the fourth message. Optionally, the second network node may determine the information in the fourth message according to at least one of the information about the address of the transmitted data received from the third network node or the first network node, the configuration information about the second network node and the information about determining the address information of the transmitted data received from the third network node. For example, the second network node may determine the address information of the transmitted data of the first network node according to the information about the address of the transmitted data received from the third network node or the first network node and the configuration information about the second network node.

Optionally, the information about determining the address information of the transmitted data may be determined by the third network node according to the fifth message received from the second network node, and the fifth message includes at least one of the following:
information about the network entity of the third network node; and
configuration information about the second network node.

Optionally, the configuration information about the second network node may include the related information on the second network node side related to the data transmission between the first network node and the second network node. When the address of the transmitted data of the first network node or the used network entity of the third network node is determined by the third network node, the configuration information may assist the third network node in determining at least one of the appropriate address and network entity for the first network node. When the used network entity of the third network node is determined by the second network node, the second network node may provide the determined related information of the network entity of the third network node to the third network node, and the third network node may determine the address information of the first network node according to the network entity determined by the second network node.

After the first network node determines by itself or knows the address information of the transmitted data determined by the second network node or the third network node, the first network node transmits a response message of the fourth message to the second network node, so as to feed the configuration used on the first network node side back to the second network node. Optionally, the response message may include the related information of the address used by the first network node (i.e., the address used to perform data transmission with the second network node). Optionally, the second network node may transmit the corresponding feedback information to the third network node to notify the third network node of the configuration used by the first network node, so that the third network node may manage the managed network node according to the feedback information.

It should be understood that, the above optional embodiments have described the communication method provided in the embodiments of the present invention by taking the first network node as an executive body, and the alternative implementations of the communication method by taking the third network node or the third network node as an executive body can be obtained according to the above description of information interaction between the first network node and another node (the second network node or the third network node). The optional embodiments of the communication method provided by the present invention will be described below from the perspective of the second network node, and the same contents in the following description as those in the above embodiments will not be repeated too much and may refer to the above description.

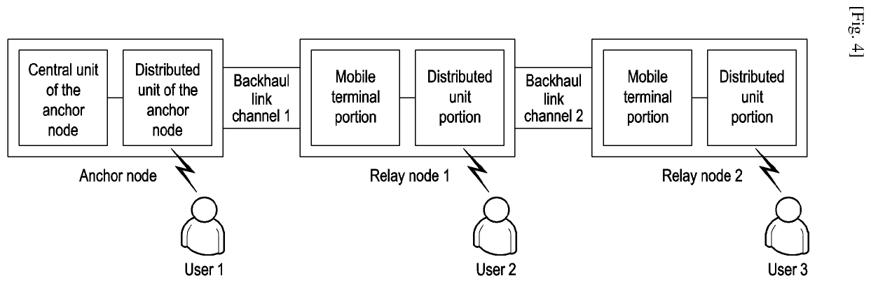

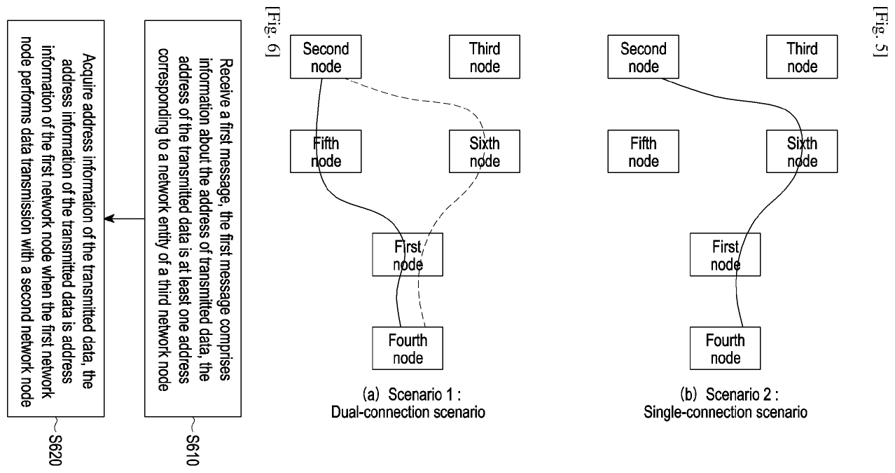

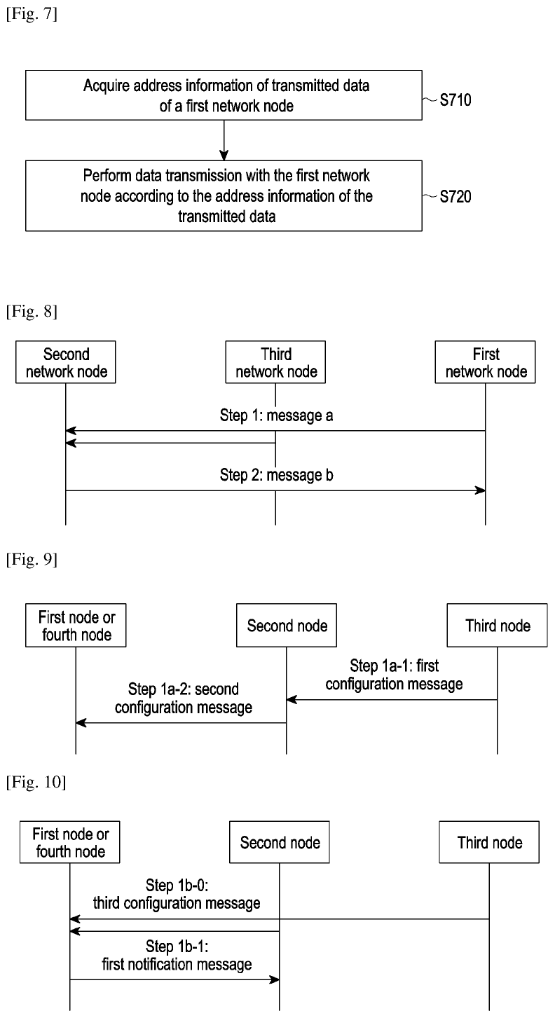

FIG. 7 shows a communication method that may be executed by a second network node according to an embodiment of the present invention. The method may include the following steps.

At S710, address information of transmitted data of a first network node is acquired, the address information of the transmitted data is address information of the first network node when performing data transmission with the second network node, the address information of the transmitted data corresponding to a network entity of a third network node.

Optionally, when the first network node and the second network node perform data transmission through the network entity of the third network node, the method further includes the following steps.

At S720, data transmission is performed with the first network node according to the address information of the transmitted data.

Optionally, the acquiring address information of transmitted data of a first network node may include at least one of the following:
way 1: determining the address information of the transmitted data of the first network node according to the information about the address of the transmitted data that is received from the first network node or the third network node; and
way 2: acquiring the address information of the transmitted data of the first network node according to an eighth message received from the first network node, the eighth message includes the information about determining the address information of the transmitted data.

The information about the address of the transmitted data is the configuration information of the first network node (which is configured by the third network node). For the way 1, the address information of the transmitted data of the first network node may be determined by the second network node; while for the way 2, the address information of the transmitted data of the first network node may be determined by the first network node or the third network node, or the network entity of the third network node used when the first network node and the second network node perform data transmission may be determined by the third network node. The second network node may know or determine the address information of the transmitted data of the first network node according to the information determined by the first network node or the third network node.

Optionally, before the acquiring address information of transmitted data of a first network node, the method further includes at least one of the following:
receiving a sixth message from the third network node or the first network node, the sixth message includes information about the address of the transmitted data;
transmitting a seventh message to the first network node, the seventh message includes the information about the address of the transmitted data.

It is to be noted that the information about the address of the transmitted data included in the sixth message and/or the seventh message may be partially or completely identical to the above information about the address of the transmitted data included in the first message. The information about the address of the transmitted data is the related information of the address for data transmission configured for the first network node by the third network node. Optionally, the address corresponding to the related information (i.e., the address used by the first network node when performing data transmission) is at least one address corresponding to the network entity of the third network node (e.g., the distributed unit of the anchor node).

Optionally, the information about the address of the transmitted data may include at least one of the following:
information about a transport layer address of the first network node; and
information about a network entity of the third network node corresponding to the transport layer address of the first network node.

Optionally, the communication method may further include at least one of the following:
transmitting a ninth message to the first network node, the ninth message includes information about determining the address information of the transmitted data;
receiving a response message of the ninth message transmitted by the first network node; and
transmitting a tenth message to the third network node, the tenth message includes at least one of the following:
information about the network entity of the third network node, and
configuration information about the second network node.

Optionally, the ninth message includes second information, and the second information indicates the address information of the transmitted data; or, the second information includes at least one of the information about the network entity of the third network node and the configuration information about the second network node, and the address information of the transmitted data corresponds to the network entity of the third network node.

The ninth message may refer to the above description of the fourth message, and the first network node may know the address information of the transmitted data of the first network node according to the ninth message. The tenth message may refer to the above description of the fifth message, and the third network node may determine the address information of the transmitted data of the first network node or the used network entity of the third network node according to the tenth message.

The communication method provided by the present invention will be described below by taking the third network node as an executive body. When the method is executed by a third network node, the method may include steps of:
transmitting an eleventh message to a first network node or a second network node, the eleventh message includes information about an address of transmitted data, the address of the transmitted data is at least one address corresponding to a network entity of a third network node.

It can be known from the above description that the address of the transmitted data includes addresses available for the first network node, for example, including the IP address or BAP address used by the first network node when the first network node transmits data to or receives data from the second network node.

Optionally, the information about the address of the transmitted data includes at least one of the following:
information about a transport layer address of the first network node; and
information about a network entity of the third network node corresponding to the transport layer address of the first network node.

Optionally, the method further includes: transmitting a twelfth message to the second network node, the twelfth message includes information about determining the address of the transmitted data.

Optionally, the twelfth message includes at least one of the following:
third information, the third information indicating the address information of the transmitted data; and, information about the network entity of the third network node.

Optionally, the method may further include at least one of the following:
receiving a thirteenth message from the second network node, the thirteenth message includes at least one of the information about the network entity of the third network node and the configuration information about the second network node;
receiving a fourteenth message from the second network node, the fourteenth message includes related information of the address information of the transmitted data; and
transmitting a response message of the fourteenth message to the second network node.

The information included in the thirteenth message may refer to the above description of the information included in the fifth message. The fourteenth message is the information fed back to the third network node by the second network node when the address information of the transmitted data of the first network node is determined. That is, the related information of the address used when the first network node and the second network node perform data transmission is notified to the third network node.

In accordance with the communication method provided by the present invention, the application requirements when the second network node and the first network node need to communication through the network entity managed by the third network node are satisfied. In accordance with the method, the configuration information of the first network node related to the data transmission address may be provided by the third network node, the network entity managed by the third network node corresponding to the address used by the first network node may be determined by the second network node or the third network node, and the address used by the first network node may be determined by the first network node or the second network node or the third network node, wherein the address is the address corresponding to the network entity managed by the third network node. Through the interaction between the first network node, the second network node and the third network node, the first network node and the second network node can know the address information used by the first network node when the first network node and the second network perform data transmission through the network entity managed by the third network node, so that the first network node and the second network can perform data transmission on the basis of the address information. During the data transmission between the first network node and the second network node, the first network node may transmit data to the second network node, or the first network node may receive data from the second network node.

The communication method provided by the present invention will be described below in detail by some specified embodiments. The method of the present invention may include two aspects: acquisition of the address of the first network node (i.e., acquisition of the configuration information about the address of the first network node and the above information about the address of the transmitted data), and selection of the address of the first network node (i.e., determination of the address of the first network node when the first network node and the second network node perform data transmission). The alternative implementations of the two aspects will be described below, respectively.

### First Aspect: Method for Acquiring the Address of the Relay Node

The first aspect mainly relates to the method for acquiring, by the anchor node (the second network node), the address of the relay node (the first network node). Optionally, the method may include the following steps, as shown in FIG. 8.

At step 1, the first network node or the third network node transmits a message a to the second network node (the name of the message will not be limited, where the message may be the second message or the third message described above). The message is used to provide the information associated with the address of the first network node (i.e., the information about the address of the transmitted data). Optionally, the message at least includes one of the following information.
Address index information: e.g., the first address index information (at step 1a-1 below) and the third address index information (at step 1b-1 below) in the following alternative implementations. The address index information indicates one index for each address. Here, each address refers to the address available for the first network node, e.g., an IP address or a BAP address, etc.
Transport layer address information: e.g., the first transport layer address information (at step 1a-1 below) and the third transport layer address information (at step 1b-1 below) in the following alternative implementations. The transport layer address information indicates the addresses such as IP addresses or BAP addresses available for the first network node. The transport layer address information may be explicit information, or may be implicit information, or may directly be addresses, or may be the related information from which the address can be obtained.
Usage information: e.g., the first usage information (at step 1a-1 below) and the third usage information (at step 1b-1 below) in the following alternative implementations. The usage information indicates the usage of the address indicated by the transport layer address information.
Associated address information: e.g., the first associated address information (at step 1a-1 below) and the third associated address information (at step 1b-1 below) in the following alternative implementations. The associated address information indicates the information (e.g., address) of the network entity associated with the transport layer address information, for example, the address of the distributed unit of the anchor node where the first network node is anchored, and the address of the distributed unit of the anchor node where the first network node performs data transmission, e.g., IP address or BAP address, etc.

Optionally, when the message a at the step 1 is transmitted to the second network node by the third network node, the method may further include the following steps.

At step 2, the second network node transmits a message b (the first message described above) to the first network node. This message is used to configure the information associated with the address for the first network node. This message at least includes one of the following information (referring to the following description of the step 1a-2).
Second address index information: the information is the index of each address configured for the first network node.
Second transport layer address information: the information may be obtained by the second network node through the transport layer address information at the step 1, and the information indicates the address of the first network node.
Second usage information: the information indicates the usage of the address corresponding to the “second transport layer address information”.
Second associated address information: the information indicates the information of the distributed unit of the anchor node associated with the “second transport layer address information”. The information may contain one or more of the “address of the distributed unit of the anchor node”, the “first indication information”, the “indication information of the cell group” and the “indication information of the topology”. The specific description of the information that may be included in the second associated address information may refer to the following description of the step 1a-2.

Optionally, the first network node may be a relay node, the second network node may be a base station, a central unit of the base station or a control plane portion of the central unit of the base station (for example, the second network node may be an anchor node), and the third network node may be a base station, a central unit of the base station or a control plane portion of the central unit of the base station. For example, in the network structure shown in FIG. 5, the first network node may be the first node or the fourth node, the third network node may be the third node, and the second network node may be the second node.

The above steps have the following beneficial effects. It is helpful for the configuration of the address information of the relay node (e.g., the first network node), and the address information (e.g., the address of the distributed unit) associated with the configured address can be notified, so that it is helpful for the relay node to select an appropriate transport layer address. Specifically, when the second network node and the first network node need to perform data transmission through the network entity managed by the third network node, the distributed unit of the anchor node passed by the data packet is controlled (configured and managed) by the third network node. The method provided by the application can assist the relay node to select an appropriate transport layer address used when performing data transmission with the second network node, and the transport layer address is associated with the network entity of the third network node.

Several alternative implementations of the first aspect will be described below.

Method 1: The anchor node (the second network node) acquires the address of the relay node (the first network node) through other anchor nodes (the third network node).

In this method, as shown in FIG. 5, the second node may acquire the address of the first node or the fourth node through the third node. The address is used by the first node or the fourth node to perform data transmission through the distributed unit of the third node. As shown in FIG. 9, the method may include the following steps.

At step 1a-1, the third node transmits a first configuration message (second message) to the second node. This message is used to notify the second node of the address of the relay bode (the first node or the fourth node). For one address, this message at least includes one of the following information.
First address index information: the information provides one index for each address.
First transport layer address information: the information is the address of the first node or the fourth node, for example, at least one of the IP address, the BAP address, etc.
First usage information: the information indicates the usage of the address indicated by the “first transport layer address information”. The usage may be one or more of the following: being used for transmitting the control plane signaling of the F1 interface, being used for transmitting the user plane data of the F1 interface, being used for transmitting the data of the non-F1 interface, etc.
First associated address information: the information indicates the address of the distributed unit of the anchor node associated with the “first transport layer address information” (e.g., the distributed unit of the anchor node where the first node or the fourth node is anchored, or the distributed unit of the anchor node where the first node or the fourth node performs data transmission), for example, at least one of the IP address or the BAP address, etc.

The name of the first configuration message may be other names, and this message may be the existing message in the existing communication standard or a newly defined message.

In one optional implementation, the first configuration message may contain an RRC container. The content in the container is generated by the third node and transmitted to the first node or the fourth node by the second node. For example, the first configuration message may be Handover Request Acknowledge, and the RRC container may be a Handover Command; or, the first configuration message may be SN addition/modification Request Acknowledge, and the RRC container may be CG-Config. The RRC container may contain the information in the first configuration message, so that the second node cannot acquire the information because the RRC container is transparently transmitted to the first node or the fourth node by the second node. Optionally, in order to allow the second node to acquire the information, the information may be placed outside the container. Thus, the information is actually transmitted for two times in the first configuration message. In other words, the configuration information generated by the third node and transmitted to the first node or the fourth node can be acquired by the second node through the first configuration message or cannot be acquired by the second node.

Optionally, the first configuration message may be a Handover Request Acknowledge message, an SN Addition/Modification Request Acknowledge message, or a newly defined message.

The step 1a-1 has the following technical effects.

\textcircled{1} The anchor node (the second node) can acquire the transport layer address information associated with the distributed unit of the other anchor node (the third node) and the address of the corresponding distributed unit, so that it is helpful for the anchor node to configure the data transmitted through the distributed unit of the other anchor node, and it is convenient for the relay node (e.g., the first node or the fourth node) to select an appropriate transport layer address.

\textcircled{2} The anchor node (the second node) can configure the transport layer address and the corresponding distributed unit address for the relay node (the first node or the fourth node), thereby assisting the relay node in selecting an appropriate transport layer address.

At step 1a-2, the second node transmits a second configuration message (the first message described above) to the first node or the fourth node. This message is used to configure an address for the relay node. For one address, this message at least includes one of the following information.
Second address index information: the information provides one index for each address.
Second transport layer address information: the information is the address of the first node or the fourth node, for example, at least one of the IP address, the BAP address, etc. The information is obtained through the first transport layer address information.
Second usage information: the information indicates the usage of the address indicated by the “second transport layer address information”. The usage may be one or more of the following: being used for transmitting the control plane signaling of the F1 interface, being used for transmitting the user plane data of the F1 interface, being used for transmitting the data of the non-F1 interface, etc. The information is obtained through the first usage information.
Second associated address information: the information indicates the information of the distributed unit of the anchor node associated with the “second transport layer address information”. Optionally, the second associated address information may at least include one of the following information.
The address of the distributed unit of the anchor node, e.g., at least one of the IP address or the BAP address, etc. In one optional embodiment, the distributed unit of the anchor node may be the distributed unit associated with the “second transport layer address information”, or the distributed unit of the anchor node where the first node or the fourth node is anchored, or the distributed unit of the anchor node where the first node or the fourth node performs data transmission.
First indication information: the indication information is used to indicate whether the anchor node to which the distributed unit indicated by the associated address belongs is an F1 interface terminated node (of the first node or the fourth node). In one optional embodiment, the indication information is non-F1-termination indication, and the indication information indicates that the anchor node to which the distributed unit indicated by the associated address belongs is not the F1 interface terminated node.
Indication information of the cell group: the information indicates the cell group used by the data transmitted through the distributed unit of the anchor node indicated by the associated address, e.g., a master cell group (MCG) indication, a secondary cell group (SCG) indication, the ID of the cell group, etc. In one optional embodiment, the information may be provided explicitly, e.g., the MCG indication, the SCG indication, the cell group ID. In another optional embodiment, the information may be provided implicitly, for example, being obtained through an information element containing the “address of the distributed unit of the anchor node” (if the information element is for the MAG, the “address of the distributed unit of the anchor node” is for the MCG; and, if the information address is for the SCG, the “address of the distributed unit of the anchor node” is for the SCG).
Indication information of the topology: the information indicates the network used by the data transmitted through the distributed unit of the anchor node indicated by the associated address. For example, in the two scenarios of FIG. 5, the indication information may be used to indicate whether the data is transmitted through the topology managed by the second node or the third node. In one embodiment, the indication information of the topology may be the ID or index of the topology, and different IDs or indexes represent different topologies.

It is to be noted that, when the first node or the fourth node selects an appropriate address, if the received information includes one or more of the “second associated address information”, the first node or the fourth node needs to select an address according to the “second transport layer address information” corresponding to the “second associated address information”. That is, the first node or the fourth node needs to select, from the addresses corresponding to the “second transport layer address information”, the address corresponding to the distributed unit of the anchor node indicated by the “second associated address information”.

Optionally, the second configuration message may be the existing message in the existing standard protocol, e.g., an RRC reconfiguration message, or may be a newly defined message.

The step 1a-2 has the following technical effects.

The anchor node (the second node) can acquire the transport layer address information associated with the distributed unit of the other anchor node (the third node) and the address of the corresponding distributed unit, so that it is helpful for the anchor node to configure the data transmitted through the distributed unit of the other anchor node, and it is convenient for the relay node to select an appropriate transport layer address.

Method 2: The anchor node (the second network node) acquires the address through the relay node (the first network node).

The method may include the following steps, as shown in FIG. 10.

At step 1b-1, the first node or the fourth node transmits a first notification message (the third message) to the second node. This message is used to notify the address information. For one address, this message at least includes one of the following information.
Third address index information: the information provides one index for each address.
Third transport layer address information: the information is the address of the first node or the fourth node, for example, at least one of the IP address, the BAP address, etc.
Third usage information: the information indicates the usage of the address indicated by the “third transport layer address information”. The usage may be one or more of the following: being used for transmitting the control plane signaling of the F1 interface, being used for transmitting the user plane data of the F1 interface, being used for transmitting the data of the non-F1 interface, etc.
Third associated address information: the information indicates the address of the distributed unit of the anchor node associated with the “third transport layer address information” (e.g., the distributed unit of the anchor node where the first node or the fourth node is anchored, or the distributed unit of the anchor node where the first node or the fourth node performs data transmission). The third associated address information may at least include one of the following information.
The address of the distributed unit of the anchor node, e.g., at least one of the IP address or the BAP address, etc. In one optional embodiment, the distributed unit of the anchor node may be the distributed unit associated with the “third transport layer address information” (e.g., the distributed unit of the anchor node where the first node or the fourth node is anchored, or the distributed unit of the anchor node where the first node or the fourth node performs data transmission).
First indication information: the indication information is used to indicate whether the anchor node to which the distributed unit indicated by the associated address information (i.e., the third associated address information) belongs is an F1 interface terminated node (of the first node or the fourth node). In one optional embodiment, the indication information is a non-F1-termination indication.
Indication information of the cell group: the information indicates the cell group used by the data transmitted through the distributed unit of the anchor node indicated by the associated address information, e.g., an MCG indication, an SCG indication, the ID of the cell group, etc. In one embodiment, the information may be provided explicitly, e.g., the MCG indication, the SCG indication, the cell group ID. In another optional embodiment, the information may be provided implicitly, for example, being obtained through an information element containing the “address of the distributed unit of the anchor node” (if the information element is for the MAG, the “address of the distributed unit of the anchor node” is for the MCG; and, if the information address is for the SCG, the “address of the distributed unit of the anchor node” is for the SCG).
Indication information of the topology: the information indicates the network used by the data transmitted through the distributed unit of the anchor node indicated by the associated address information. For example, in the two scenarios of FIG. 5, the indication information may be used to indicate whether the data is transmitted through the topology managed by the second node or the third node. In one embodiment, the indication information of the topology may be the ID or index of the topology, and different IDs or indexes represent different topologies.

Optionally, before the step 1b-1, the method may further include a step 1b-0: the first node or the fourth node receives a third configuration message from the second node or the third node. This message is used to configure the address. Optionally, the configured address may be the address (e.g., the third transport layer address information, the third associated address information, etc.) included in the first notification message at the step 1b-1.

Optionally, the first node or the fourth node may acquire the third configuration message from the second node. For example, the third configuration message may be the second configuration message at the step 1a-2. Optionally, the first node or the fourth node may directly acquire the third configuration message from the third node.

At the two steps (steps 1b-0 and 1b-1), optionally, the address information may be firstly configured for the first node or the fourth node by the second node and then notified to the second node by the first node or the fourth node. The reason for performing this process is that, the address information configured at the step 1b-0 is that the second node transmits the information (including the address information) from the other node (the third node) to the fourth node or the fourth node in a transparent transmission manner, so that the second node actually does not know the address information of the first node or the fourth node. Therefore, the address information may be notified to the second node by the first node or the fourth node through the step 1b-1.

The first notification message may be the existing message in the existing communication standard protocol, or a newly defined message. For example, the first notification message may be a gNB-DU Configuration Update message.

In accordance with the alternative implementations of the first aspect, the first network node can acquire the related configuration information of the address of the first network node. Optionally, the second network node may also acquire the related configuration information of the address of the first network. The source of the related configuration information of the address of the first network node is configured by the third network, and an appropriate transport layer address may be selected for the first network node on the basis of the related configuration information, to perform data transmission between the first network node and the second network node through the network entity (e.g., the distributed unit) of the third network node.

Second aspect: Selection of the address of the relay node (i.e., determination of the address information of the first network node)

In order to complete the selection of the address of the relay node, it is necessary to solve the following two problems:

\textcircled{1} which node determines the address of the relay node; and, \textcircled{2} which node determines the distributed unit of the anchor node passed by the data of the relay node.

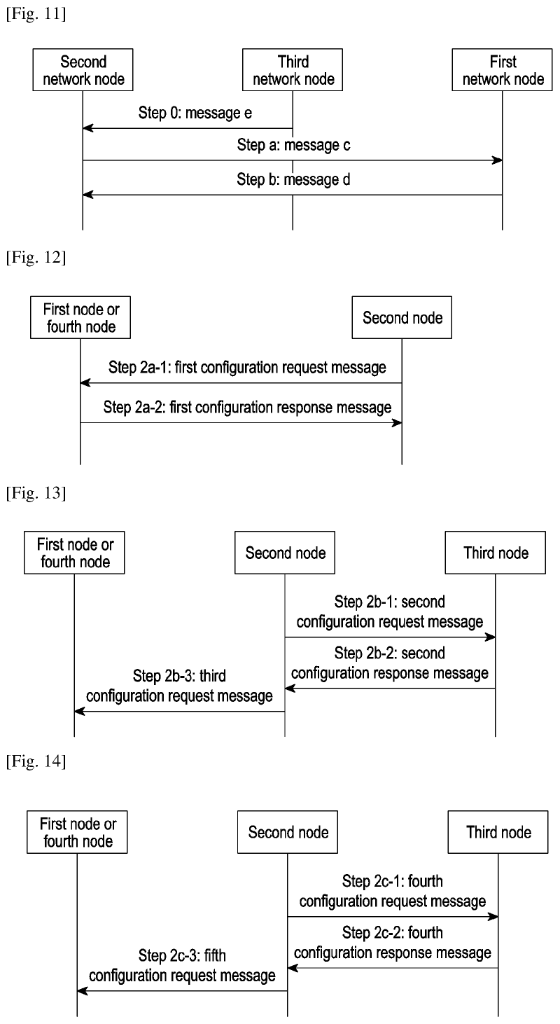

In order to solve the above problems, the method in the second aspect of the present invention may include the following process shown in FIG. 11.

At step a, the second network node transmits a message c (the fourth message described above) to the first network node. This message is used to provide assistant information for assisting the first network node in selecting an appropriate address. This message at least includes one of the following information.
First address information: the information indicates the address to be used by the first network node to perform data transmission, e.g., the fourth transport layer address information (at steps 2a-1, 2b-3 and 2c-3) in the following alternative implementations.
Information about the bearer: e.g., the information about the first bearer (the message at steps 2a-1, 2b-3 and 2c-3 below may contain the information about the bearer), and the information about the second bearer (the information about the bearer that may be included in the message at steps 2d-1 and 2e-1 below) in the following alternative implementations.
Information about the non-user plane data, e.g., the information about the first non-user plane data (the information about the bearer that may be included in the message at steps 2d-1 and 2e-1) in the following alternative implementations.

At step b, the first network node transmits a message d (e.g., the response message of the fourth message) to the second network node. This message indicates that the first network node sets the address used during data transmission according to the content in the third message. In one optional embodiment, the first network node may set the address according to the first address information. In another optional embodiment, the first network node may set the address according to the information about the bearer and/or the information about the non-user plane data (e.g., the fourth associated address information in the following alternative implementations).

Optionally, before the step a, the method may further include the following step.

At step 0, the third network node transmits a message e (the eighth message described above) to the second network node. This message is used to provide assistant information for assisting the first network node in selecting an appropriate address. This message at least includes one of the following information.
Data traffic identifier information: the information may be the identifier information of the data traffic to be transmitted by the first network node, e.g., the traffic ID, DRB ID, tunnel ID or the like corresponding to the data traffic.
Second address information: e.g., the sixth transport layer address information (at step 2b-2 below) and the eighth transport layer address information (at step 2c-2 below) in the following alternative implementations.
Address index information: the address index information may be the index information of the address corresponding to the “second address information”.
Third address information: e.g., the seventh transport layer address information (at step 2b-2 below) and the ninth transport layer address information (at step 2c-2 below) in the following alternative implementations.

The step a may occur after the step 1 and/or step 2.

Similarly, the first network node may be the first node or the fourth node, the third network node may be the third node, and the second network node may be the second node.

The above steps have the following beneficial effects. It is helpful for the relay node to select an appropriate address, thereby ensuring that the address can correspond to the distributed unit of the anchor node passed by the transmitted data, and ensuring that the data can reach the destination receiving node.

During the implementation of the second aspect, according to different nodes that determine the address of the relay node and the distributed unit of the anchor node, the above process has the following possible implementations.

Implementation 1: the second node determines the address of the relay node and the distributed unit of the anchor node.

This implementation includes the following steps, as shown in FIG. 12.

Step 2a-1: the second node transmits a first configuration request message (an alternative of the fourth message) to the first node or the fourth node. This message is mainly used to provide the selected address, and this message at least includes one of the following information.
Fourth transport layer address information: the information indicates the address used for data transmission on the first node side or fourth node side, e.g., the IP address. Further, the address is used by the first node or the fourth node to receive downlink data. In one optional embodiment, the address indicated by the information is used for data transmission by the first node or the fourth node to transmit data, e.g., transmitting data. In another optional embodiment, the address indicated by the information is used by the first node or the fourth node to transmit control signaling. In still another optional embodiment, the address indicated by the information is used by the first node or the forth node to transmit user plane data. In still another optional embodiment, the address indicated by the information is used to transmit the data of one or more bearers. In addition, the address may be the address associated with the distributed unit managed by the third node. It should be understood that the address indicated by the fourth transport layer address information may be one or more addresses. For example, the address may include at least one address used for transmitting data and/or at least one address used for transmitting signaling.
Information about the first bearer: the bearer may be a newly-built bearer or a modified bearer. For a bearer, the information at least includes one of the following information.
Identifier information of the bearer
Quality of service (QoS) information of the bearer
Tunnel information of the bearer: one bearer may have one or more tunnels, and for a tunnel, the information at least includes one of the following information.
First uplink transport layer address information: the information indicates the address (e.g., IP address) of the second node side, and the address is an address for receiving uplink data.
Tunnel endpoint identifier information, i.e., tunnel endpoint ID.
Route identifier information: the information is used to indicate the identifier of the route used for transmitting uplink data. In one embodiment, the identifier information includes at least one of the BAP address information and the route identifier information. Optionally, the BAP address indicates the address information of the destination (e.g., the distributed unit of the anchor node) of uplink data.
Fifth transport layer address information: the information indicates the address (e.g., IP address) of the first node side or fourth node side, and the address is used by the first node or the fourth node to receive downlink data. In one optional embodiment, the address information may be determined by the second node. Further, the address information also determines the distributed of the anchor node passed by the downlink data (that is, the address information is the address information corresponding to the distributed unit of the anchor node passed by the downlink data). Optionally, the address may be associated with the distributed unit managed by the third node. The address information is different from that in the prior art. In the prior art, the address of the first node side or fourth node side is determined by the first node or fourth node itself. In this optional solution of the present invention, the address information indicates that the address of the first node side or fourth node side is determined by the second node and then transmitted to the first node or the fourth node, that is, the address information may be determined by the second node. Further, the first node or the fourth node may set the transport layer address of the downlink tunnel (i.e., the tunnel for transmitting data between the first node/fourth node and the second node) according to the address information.

Optionally, this implementation may further include a step 2a-2: the first node or the fourth node transmits a first configuration response message (the response message of the fourth message). This message is mainly used to feed back the configuration of the first node side or fourth node side, and the address of the first node side or fourth node side included in this message may be set according to the “fourth transport layer address information” or the “fifth transport layer address information” received at the step 2a-1.

The first configuration request message may be the existing message in the existing communication standard protocol or a newly defined message. For example, the first configuration request message may be a UE Context Setup/Modification Request message, a gNB-CU configuration update message, a gNB-DU configuration update acknowledge message, or an F1 SETUP Response message.

Implementation 2: the second node determines the distributed unit of the anchor node, and the third node determines the address of the relay node.

This implementation includes the following steps, as shown in FIG. 13.

At step 2b-1: the second node transmits a second configuration request message (an alternative of the tenth message or the thirteenth message) to the third node. This message is used to provide the information of the second node side used to transmit the data (or data traffic) of the relay node, thereby assisting the third node in generating the information of the third node side used to transmit the data. Transmitting this message is because the second node expects to perform data transmission with the first node or the fourth node through the network managed by the third node. There may be various types of transmitted data (or data traffic), and each type of data (or data traffic) may belong to one bearer, or one tunnel, or multiple tunnels, or one type of control signaling. For one type of data, this message at least includes one of the following information.
Data traffic identifier information, e.g., Traffic ID, DRB ID, tunnel ID, etc.
Sixth transport layer address information: the information is the address information (e.g., IP address) used when the first node or the fourth node performs data transmission. In one embodiment, the address information is the address used when the first node or the fourth node performs transmission through the network under the second node. Optionally, in order to identify each address, the information may further include the address index information of each address.
First distributed unit address information: the address information indicates the address (e.g., BAP address) of the distributed unit of the anchor node under the network managed by the third node. In one optional embodiment, the address information may be selected by the second node (that is, the second node determines the distributed unit). In one optional embodiment, the address information may be obtained by the second node through the “first associated address information” at the step 1a-1. In another embodiment, the information may be obtained by the second node through the “third associated address information” at the step 1b-1.

At step 2b-2, the third node transmits a second configuration response message (an alternative of the eighth message or the twelfth message). This message is used to provide the information of the third node side used to transmit the data (or data traffic) of the relay node. There may be various types of transmitted data (or data traffic), and each type of data (or data traffic) may belong to one bearer, or one tunnel, or multiple tunnels, or one type of control signaling. For one type of data, this message at least includes one of the following information.
Data traffic identifier information, e.g., Traffic ID, DRB ID, tunnel ID, etc.
Sixth transport layer address information
Address index information: the information is the index information about the “sixth transport layer address information” at the step 2b-1.
Seventh transport layer address information: the information is the address information (e.g., IP address) used when the first node or the fourth node performs data transmission. In one embodiment, the address information is the address used when the first node or the fourth node performs transmission through the network under the third node. Further, the information is used to replace the “sixth transport layer address information” used when the first node or the fourth node performs data transmission. That is, when the first node or the forth node performs data transmission with the second node through the network under the third node, the address used by the first node or the fourth node should be the address corresponding to the network entity of the third node (e.g., the distributed unit of the anchor node), the first node or the fourth node transmits data to the second node or the second node transmits data to the first node or the fourth node, and the address used by the first node or the fourth node should be the address information.

Optionally, this optional implementation may further include a step 2b-3: the second node transmits a third configuration request message (an alternative of the fourth message) to the first node or the fourth node. This message is used to configure the address information when the first node or the fourth node performs data transmission through the network managed by the third node. The information included in this message may refer to the description of the information included in the first configuration request message at the step 2a-1.

Optionally, after the step 2b-3, the first node or the fourth node may also feed the configuration information, i.e., the response message of the fourth message, back to the second node.

At least one of the second configuration request message and the second configuration response message may be the existing message in the existing communication standard protocol, or a newly defined message. For example, the second configuration request message and the second configuration response message may be a Handover request message and a Handover request acknowledge message, respectively; or, the second configuration request message and the second configuration response message may be an SN addition request and an SN addition request acknowledge, respectively; or, the second configuration request message and the second configuration response message may be an SN modification request and an SN modification request acknowledge, respectively.

Similarly, the third configuration request message may be the existing message in the existing communication standard protocol, or a newly defined message. For example, the third configuration request message may be a UE Context Setup/Modification Request message, a gNB-CU configuration update message, a gNB-DU configuration update acknowledge message or an F1 SETUP Response message.

Implementation 3: the third node determines the address of the relay node and the distributed unit of the anchor node.

This implementation may include the following steps, as shown in FIG. 14.

At step 2c-1, the second node transmits a fourth configuration request message to the third node. This message is used to provide the information of the second node side used to transmit the data (or data traffic) of the relay node, thereby assisting the third node in generating the information of the third node side used to transmit the data. Transmitting this message is because the second node expects to perform data transmission with the first node or the fourth node through the network managed by the third node. There may be various types of transmitted data (or data traffic), and each type of data (or data traffic) may belong to one bearer, or one tunnel, or multiple tunnels, or one type of control signaling. For one type of data, this message at least includes one of the following information.
Data traffic identifier information, e.g., Traffic ID, DRB ID, tunnel ID, etc.
Eighth transport layer address information: the information is the address information (e.g., IP address) used when the first node or the fourth node performs data transmission. In one embodiment, the address information is the address used when the first node or the fourth node performs transmission through the network under the second node. Further, in order to identify each address, the information may further include the address index information.

At step 2c-2, the third node transmits a fourth configuration response message to the second node. This message is used to provide the information of the third node side used to transmit the data (or data traffic) of the relay node. There may be various types of transmitted data (or data traffic), and each type of data (or data traffic) may belong to one bearer, or one tunnel, or multiple tunnels, or one type of control signaling. For one type of data, this message at least includes one of the following information.
Data traffic identifier information, e.g., Traffic ID, DRB ID, tunnel ID, etc.
Eighth transport layer address information
Address index information: the information is the index information about the “eighth transport layer address information” at the step 2c-1.
Ninth transport layer address information: the information is the address information (e.g., IP address) used when the first node or the fourth node performs data transmission. In one embodiment, the address information is the address used when the first node or the fourth node performs transmission through the network under the third node. Further, the information is used to replace the “eighth transport layer address information” used when the first node or the fourth node performs data transmission.

At step 2c-3, the second node transmits a fifth configuration request message to the first node or the fourth node. This message is used to configure to perform data transmission through the network managed by the third node. The information included in this message may refer to the description of the step 2a-1.

After the step 2c-3, the first node or the fourth node may also feed back the configuration information to the second node.

The fourth configuration request message and the fourth configuration response message may be a Handover request/Handover request acknowledge message, an SN addition request/SN addition request acknowledge message or an SN modification request/SN modification request acknowledge message, respectively, or may be newly defined messages.

The fifth configuration request message may be a UE Context Setup/Modification Request message, a gNB-CU configuration update message, a gNB-DU configuration update acknowledge message, an F1 SETUP Response message, or a newly defined message.

Implementation 4: the second node determines the distributed unit of the anchor node, and the first node or the fourth node determines the address of the relay node.

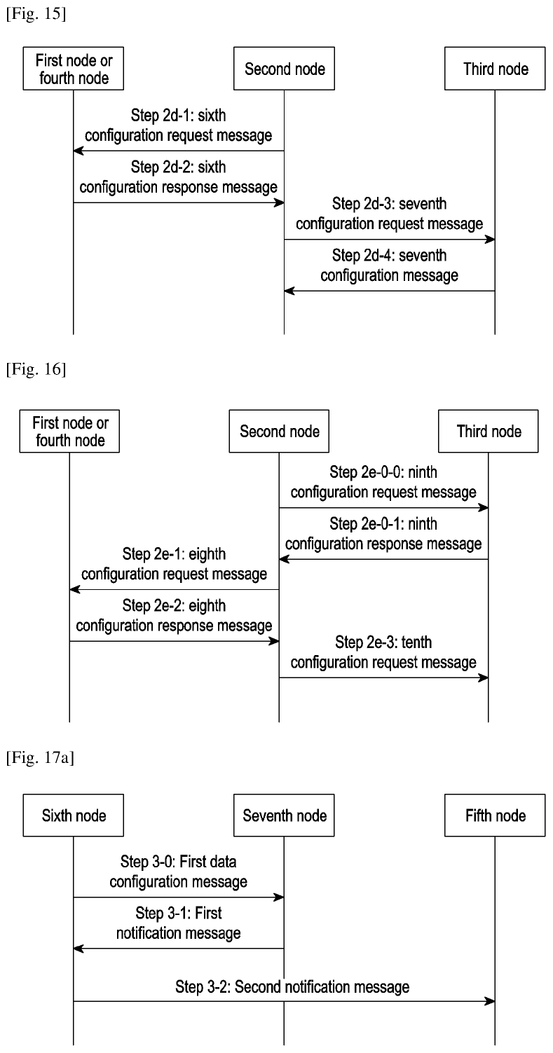

This implementation includes the following steps, as shown in FIG. 15.

At step 2d-1, the second node transmits a sixth configuration request message (an alternative of the fourth message) to the first node or the fourth node. This message is mainly used to provide the configuration information of the second node side. This message at least includes one of the information about the second bearer and the information about the first non-user plane data below.
Information about the second bearer: the bearer may be a newly-built bearer or a modified bearer. For a bearer, the information at least includes one of the following information.
Identifier information of the bearer
QoS information of the bearer
Tunnel information of the bearer: one bearer may have one or more tunnels, and for a tunnel, the information at least includes one of the following information.
First uplink transport layer address information: the information indicates the address (e.g., IP address) of the second node side, and the address is an address for receiving uplink data.
Tunnel endpoint identifier information, i.e., tunnel endpoint ID
Route identifier information: the information is used to indicate the identifier of the route used for transmitting uplink data. In one embodiment, the identifier information may include at least one of the BAP address information and the route identifier information. Further, the BAP address information indicates the address information of the destination of uplink data.
Fourth associated address information: the information indicates the information of the distributed unit of the anchor node associated with the downlink data (e.g., the distributed unit of the anchor node where the first node or the fourth node is anchored, or the distributed unit of the anchor node where the first node or the fourth node performs data transmission). The information may be used by the first node or the fourth node to select an appropriate transport layer address. The fourth associated address information may at least include one of the following information.
Address of the distributed unit of the anchor node: e.g., at least one of the IP address, the BAP address, etc. In one embodiment, the distributed unit of the anchor node is the distributed unit under the network managed by the third node.
First indication information: the indication information is used to indicate whether the anchor node to which the distributed unit indicated by the associated address information belongs is an F1 interface terminated node (of the first node or the fourth node). In one embodiment, the indication information is a non-F1-termination indication.
Indication information of the cell group: the information indicates the cell group used by the data transmitted through the distributed unit of the anchor node indicated by the associated address information, e.g., the MCG indication, the SCG indication, the ID of the cell group, etc. In one embodiment, the information may be provided explicitly, e.g., the MCG indication, the SCG information and the Cell Group ID. In another optional embodiment, the indication information may be indicated implicitly, for example, being indicated implicitly through the information in the CG-Config 1E.
Indication information of the topology: the information indicates the network used by the data transmitted through the distributed unit of the anchor node indicated by the associated address information. For example, in the two scenarios of FIG. 5, the indication information may be used to indicate whether the data is transmitted through the topology managed by the second node or the third node. In one embodiment, the indication information of the topology may be the ID or index of the topology, and different IDs or indexes represent different topologies.

The “fourth associated address information” may be obtained by the second node through the “first associated address information” at the step 1a-1, or may be obtained by the second node through the “third associated address information” at the step 1b-1. In other words, the first associated address information may be obtained on the basis of the related configuration information about the address of the transmitted data that is provided to the first node or the fourth node by the third node.
Information about the first non-user plane data: the information at least includes one of the following information.
Indication information of the data type: the data type indicated by the information is one or more of the following types: F1 control signaling, user-related F1 control signaling, non-user-related control signaling, and non-F1 interface data.
Route identifier information: the information is used to indicate the identifier of the route used for transmitting uplink data. In one embodiment, the identifier information includes at least one of the BAP address information and the route identifier information. Further, the BAP address indicates the address information of the destination of uplink data.
Fifth associated address information: the specific description of the information may refer to the description of the “information about the second bearer” at this step. The information may include one or more of the information (e.g., the address of the distributed unit of the anchor node, the first indication information, the indication information of the cell group, the indication information of the topology, etc.) included in the “information about the second bearer”.

Optionally, this optional implementation may further include a step 2d-2: the first node or the fourth node transmits a sixth configuration response message (an alternative of the response message of the fourth message) to the second node. This message is mainly used to feed back the configuration of the first node side or fourth node side. Optionally, the address of the first node side or fourth node side included in this message may be set according to the “fourth associated address information” received at the step 2d-1, and the transport layer address associated with the “fourth associated address information” or the “fifth associated address information” is obtained by the first node or the fourth node through the step 1a-2 or 1b-0. That is, the first node or the fourth node may determine the used transport layer address according to the first message and the fourth message.

Further, optionally, after the step 2d-2, the method may further include the following steps.

At step 2d-3, the second node transmits a seventh configuration request message to the third node. This message is used to provide the third node with the information of the first node side or fourth node side (e.g., the related information of the used transport layer address; the transport layer address of the first node side or fourth node side provided at this step is the address fed back to the second node at the step 2d-2).

At step 2d-4: the third node transmits a seventh configuration response message (i.e., the response of the seventh configuration request message) to the second node. This message provides the information of the third node side (e.g., the configuration information used when the third node side transmits the data of the first node or the fourth node, e.g., the information of the backhaul link channel, route identifier information, etc.).

At least one of the sixth configuration request message, the sixth configuration response message, the seventh configuration request message and the seventh configuration response message may be the existing message in the existing communication standard protocol, or a newly defined message.

Optionally, the sixth configuration request message may be a UE Context Setup/Modification Request message, a gNB-CU configuration update message, a gNB-DU configuration update acknowledge message, an F1 SETUP Response message, or a newly defined message. The sixth configuration response message may be a UE Context Setup/Modification Response message, a gNB-CU configuration update acknowledge message, or a newly defined message.

Optionally, the seventh configuration request message and the seventh configuration response message may be a Handover request message and a Handover request acknowledge message, respectively; or, the seventh configuration request message and the seventh configuration response message may be an SN addition request message and an SN addition request acknowledge message, respectively; or, the seventh configuration request message and the seventh configuration response message may be an SN modification request message and an SN modification request acknowledge message, respectively.

Implementation 5: the third node determines the distributed unit of the anchor node, and the first node or the fourth node determines the address of the relay node.

This implementation includes the following steps, as shown in FIG. 16.

At step 2e-1, the second node transmits an eighth configuration request message (an alternative of the fourth message) to the first node or the fourth node. This message is used to configure the data transmission of the first node or the fourth node. The content included in this message may refer to the information included in the sixth configuration request message at the step 2d-1. The eighth configuration request message differs from the sixth configuration information in that: with regard to the information of the distributed unit of the associated anchor node, this information in the eighth configuration request message is determined by the third node, while this information in the sixth configuration request message is determined by the second node.

Optionally, this optional implementation may further include a step 2e-2: the first node or the fourth node transmits an eighth configuration response message to the second node. This message is mainly used to feed back the configuration of the first node side or fourth node side. The transport layer address of the first node side or fourth node side included in this message is set according to the “associated address information” (which may refer to the “fourth associated address information” or the “fifth associated address information” in the sixth configuration request message) received at the step 2e-1, and the transport layer address associated with the “associated address information” is obtained by the first node or the fourth node through the step 1a-2 or the step 1b-0.

In order to obtain the “associated address information” at the step 2e-1, before the step 2e-1, this optional implementation may further include the following steps.

At step 2e-0-0, the second node transmits a ninth configuration request message (an alternative of the fifth message or the tenth message) to the third node. This message includes the configuration information about the first node or the fourth node on the second node side. This message may include the transport layer address used when the first node or the fourth node performs data transmission, and this address is associated with the network entity of the second node, for example, being associated with the distributed unit managed by the second node. The specific content included in this request message may refer to the content included in the fourth configuration request message at the step 2c-1.

At step 2e-0-1, the third node transmits a ninth configuration response message (the information associated with determining the address information of the transmitted data which is received by the second network node from the third network node) to the second node. This message includes the configuration information of the third node side used when transmitting the data of the first node or the fourth node, e.g., the information of the backhaul link channel, the route identifier information, etc.

Further, optionally, after the step 2e-2, this optional implementation may further include the following steps.

At step 2e-3, the second node transmits a tenth configuration request message (an alternative of the fourteenth message) to the third node. This message is mainly used to update the transport layer address used by the first node side or fourth node side, and the address is the address related to the distributed unit managed by the third node selected according to the “associated address information”. This step is to update the transport layer address transmitted to the third node by the second node at the step 2e-0-0 by using this address.

At least one of the eighth configuration request message, the eighth configuration response message, the ninth configuration request message, the ninth configuration response message and the tenth configuration request message may be the existing message in the existing communication standard protocol, or a newly defined message.

Optionally, the eighth configuration request message may be a UE Context Setup/Modification Request message, a gNB-CU configuration update message, a gNB-DU configuration update acknowledge message, an F1 SETUP Response message, or a newly defined message. The eighth configuration response message may be a UE Context Setup/Modification Response message, a gNB-CU configuration update acknowledge message, or a newly defined message.

Optionally, the ninth configuration request message and the ninth configuration response message may be a Handover request message and a Handover request acknowledge message, respectively; or, the ninth configuration request message and the ninth configuration response message may be an SN addition request and an SN addition request acknowledge message, respectively; or, the ninth configuration request message and the ninth configuration response message may be an SN modification request message and an SN modification request acknowledge message, respectively.

Optionally, the tenth configuration message may be a Handover Request message, an SN addition request message, an SN modification request message, or a newly defined message.

Implementation 6: the third node determines the distributed unit of the anchor node, and the second node determines the address of the relay node.

This implementation may include the following steps.

At step 2f-1, the second node transmits an eleventh configuration request message to the third node. This message is used to provide the information of the second node side used to transmit the data (or data traffic) of the relay node, thereby assisting the third node in generating the information of the third node side used to transmit the data. Transmitting this message is because the second node expects to perform data transmission with the first node or the fourth node through the network managed by the third node. There may be various types of transmitted data (or data traffic), and each type of data (or data traffic) may belong to one bearer, or one tunnel, or multiple tunnels, or one type of control signaling. For one type of data, this message at least includes one of the following information.
Data traffic identifier information, e.g., Traffic ID, DRB ID, tunnel ID, etc.
Tenth transport layer address information: the information is the address information (e.g., IP address) used when the first node or the fourth node performs data transmission. In one embodiment, the address information is the address used when the first node or the fourth node performs transmission through the network under the second node. Further, in order to identify each address, the information may further include the address index information.

At step 2f-2, the third node transmits an eleventh configuration response message to the second node. This message is used to provide the information of the third node side used to transmit the data (or data traffic) of the relay node. There may be various types of transmitted data (or data traffic), and each type of data (or data traffic) may belong to one bearer, or one tunnel, or multiple tunnels, or one type of control signaling. For one type of data, this message at least includes one of the following information.
Data traffic identifier information, e.g., Traffic ID, DRB ID, tunnel ID, etc.
Second distributed unit address information: the address information indicates the address (e.g., BAP address) of the distributed unit of the anchor node under the network managed by the third node (that is, the third node determines the distributed unit).

At step 2f-3, the second node transmits a twelfth configuration request message to the first node or the fourth node. This message is used to configure to perform data transmission through the network managed by the third node. The information included in this message may refer to the description of the step 2a-1. Further, the address information of the first node or the fourth node selected by the second node at this step may be obtained according to the method in the aspect of the present invention. That is, the second node may select the address information for the first node or the fourth node according to the related configuration information provided to the first node by the third node in the first aspect and the information in the eleventh configuration response message.

Optionally, this implementation may further include a step 2f-4: the first node or the fourth node transmits a twelfth configuration response message to the second node. This message is mainly used to feed back the configuration of the first node side or fourth node side, and the address of the first node side or fourth node side included in this message may be set according to the twelfth configuration request information received at the step 2f-3. Optionally, the address may be set according to the “transport layer address information” included in the twelfth configuration request message. The “transport layer address information” may refer to at least one of the “fourth transport layer address information” or the “fifth transport layer address information” at the step 2a-1.

The eleventh configuration request message and the eleventh configuration response message may be a Handover request/Handover request acknowledge message, an SN addition request/SN addition request acknowledge message or an SN modification request/SN modification request acknowledge message, respectively, or may be newly defined messages.

The twelfth configuration request message may be a UE Context Setup/Modification Request message, a gNB-CU configuration update message, a gNB-DU configuration update acknowledge message, an F1 SETUP Response message, or a newly defined message.

The six alternative implementations of the second aspect have the following beneficial effects. The assistant information can be provided for the relay node to assist the relay node in selecting an appropriate address, thereby ensuring that the address can correspond to the distributed unit of the anchor node passed by the transmitted data, and ensuring that the data can reach the destination receiving node. The selection of the address of the relay node may be determined by the first network node, the second network node or the third network node. In the process of selecting the address of the relay node, the distributed unit of the anchor node associated with the address may be determined by the second network node or the third network node.

It is to be noted that the solutions provided in the above embodiments of the present invention may refer to each other and be combined with each other. For example, in the embodiments described by taking the first network node as the executive body of the communication method, for the information interaction between the first network node and other network nodes (the second network node or the third network node), the steps executed by other network nodes can also be obtained. For example, the first network node receives information/messages from the second network node, and correspondingly, the second network node transmits information/messages to the first network node. For some messages/information with different names in various embodiments, according to the description of the messages/information, reference can also be made to the explanations of the contents included in the messages/information with different names. For example, for the messages with different names containing the information about the address of data transmission, reference can be made to the information about the address of data transmission included in these messages.

Based on the same principle as the method provided in the embodiments of the present invention, an embodiment of the present invention further provides a network node in a wireless communication system, wherein this network node (a first network node, e.g., a relay node) includes a first information processing module configured to:
receive a first message, the first message includes information about an address of transmitted data, the address of the transmitted data is at least one address corresponding to a network entity of a third network node; and
acquire the address information of the transmitted data, the address information of the transmitted data is address information of the first network node when the first network node performs data transmission with a second network node.

Optionally, the first information processing module may execute at least one of the following:
receiving a first message from the third network node; and
receiving a first message from the second network node, the first message is obtained by the second network node according to a second message received from the third network node.

Optionally, the first information processing module is further configured to: transmit a third message to the second network node according to the first message, the third message includes the information about the address of the transmitted data.

Optionally, the information about the address of the transmitted data includes at least one of the following:
information about a transport layer address of the first network node; and, information about a network entity of the third network node corresponding to the transport layer address of the first network node.

Optionally, the first information processing module may be configured to:
receive a fourth message from the second network node, and acquire the address information of the transmitted data according to the fourth message, the fourth message includes information about determining the address information of the transmitted data.

Optionally, the fourth message is generated by the second network node according to at least one of the following:
information about the address of the transmitted data that is received from the third network node or the first network node;
information about determining the address information of the transmitted data that is received from the third network node; and
configuration information about the second network node.

Optionally, the information about determining the address information of the transmitted data is determined by the third network node according to the fifth message received from the second network node, and the fifth message includes at least one of the following:
information about the network entity of the third network node; and
configuration information about the second network node.

Optionally, the fourth message includes first information, and the first information indicates the address information of the transmitted data.

Optionally, the first information processing module is configured to: determine the address information of the transmitted data according to the first message and the fourth message, wherein the fourth message includes at least one of the following:
information about the network entity of the third network node, the address information of the transmitted data corresponding to the network entity of the third network node; and
configuration information about the second network node.

Optionally, the first information processing module is further configured to: transmit a response message of the fourth message to the second network node.

An embodiment of the present invention further provides a network node in a wireless communication system, wherein the network node (a second network node) includes a second information processing module configured to:
acquire address information of transmitted data of a first network node; and
perform data transmission with the first network node according to the address information of the transmitted data;
wherein the address information of the transmitted data is address information of the first network node when the first network node performs data transmission with a second network node, and the address information of the transmitted data corresponds to a network entity of a third network node.

Optionally, the second information processing module is further configured to: execute at least one of the following before the address information of the transmitted data of the first network node is acquired:
receiving a sixth message from the third network node or the first network node, the sixth message includes information about the address of the transmitted data;
transmitting a seventh message to the first network node, the seventh message includes the information about the address of the transmitted data.

Optionally, the information about the address of the transmitted data includes at least one of the following:
information about a transport layer address of the first network node; and, information about a network entity of the third network node corresponding to the transport layer address of the first network node.

Optionally, the second information processing module is configured to execute at least one of the following:
determining the address information of the transmitted data of the first network node according to the information about the address of the transmitted data that is received from the first network node or the third network node; and
acquiring the address information of the transmitted data of the first network node according to an eighth message received from the first network node or the third network node, the eighth message includes the information about determining the address information of the transmitted data.

Optionally, the second information processing module is further configured to execute at least one of the following:
transmitting a ninth message to the first network node, the ninth message includes information about determining the address information of the transmitted data;
receiving a response message of the ninth message transmitted by the first network node; and
transmitting a tenth message to the third network node, the tenth message includes at least one of the following:
information about the network entity of the third network node; and
configuration information about the second network node.

Optionally, the ninth message includes second information, and the second information indicates the address information of the transmitted data.

Optionally, the second information includes at least one of the information about the network entity of the third network node and the configuration information about the second network node, and the address information of the transmitted data corresponds to the network entity of the third network node.

Optionally, the ninth message includes indication information of the network entity of the third network node.

An embodiment of the present invention further provides a network node in a wireless communication system, wherein the network node (a third network node) includes a third information processing module configured to:
transmit an eleventh message to a first network node or a second network node, the eleventh message includes information about an address of transmitted data, the address of the transmitted data is at least one address corresponding to a network entity of a third network node.

Optionally, the information about the address of the transmitted data includes at least one of the following:
information about a transport layer address of the first network node; and, information about a network entity of the third network node corresponding to the transport layer address of the first network node.

Optionally, the third information processing module is further configured to: transmit a twelfth message to the second network node, the twelfth message includes information about determining the address of the transmitted data.

Optionally, the twelfth message includes at least one of the following:
third information, the third information indicating the address information of the transmitted data; and, information about the network entity of the third network node.

Optionally, the third information processing module is further configured to execute at least one of the following:
receiving a thirteenth message from the second network node, the thirteenth message includes at least one of the information about the network entity of the third network node and the configuration information about the second network node;
receiving a fourteenth message from the second network node, the fourteenth message includes related information of the address information of the transmitted data; and
transmitting a response message of the fourteenth message to the second network node.

An embodiment of the present invention further provides another network node, wherein the network node includes:
at least one transceiver; and
at least one processor, the at least one processor is coupled to the transceiver and configured to: implement the method executed by the first network node, or the method executed by the second network node, or the method executed by the third network node.

The network nodes according to the embodiments of the present invention can execute the methods according to the embodiments of the present invention, and the implementation principles thereof are similar. The acts executed by the modules in the network nodes according to the embodiments of the present invention correspond to the steps in the methods according to the embodiments of the present invention. The detailed functional description of the modules in the network nodes can refer to the description of the corresponding methods described above and will not be repeated here.

The above optional embodiments are the technical solutions provided in the first aspect of the present invention.

The contents in the second aspect of the present invention relate to the contents of performing small data transmission in a non-relay network or a relay network by a user equipment in an inactive state. The small data transmission of the user may be caused by the presence of data to be transmitted on the user side or may be caused by the presence of data to be transmitted on the network side. In the prior art, the small data transmission triggered on the user side is mainly processed, but there are no corresponding mechanisms for the small data transmission triggered on the network side. The contents in the second aspect of the present invention mainly assist the user in performing small data transmission triggered on the network side. The specific technical problem is how the network side triggers the user to perform small data transmission. That is, after the base station serving the user receives user data, the base station needs to determine whether to trigger the user to perform small data transmission or trigger the user to enter a connected state for normal data transmission.

It is to be noted that, the names of the terms (e.g., the names of some nodes, messages, information, etc.) involved in the technical solutions provided in the first aspect of the present invention may not be related to the names of the terms involved in the technical solutions provided in the second aspect of the present invention, and the description of the terms in the solutions provided in the first aspect should not be interpreted as limiting the same or similar terms present in the second aspect. Similarly, the description of the terms in the solutions provided in the second aspect should not be interpreted as limiting the same or similar terms present in the first aspect.

In order to solve the technical problem, the present invention defines the following nodes.
Fifth node: it is a user equipment. This node may be a user equipment that is directly connected to the base station or a user equipment that is connected to the base station through a relay node.
Sixth node: it is a control plane portion of the central unit of the base station. This node belongs to the base station serving the fifth node, and the base station may be a base station that is directly connected to the fifth node or a base station that is connected to the user through a relay node, for example, an anchor node. When the fifth node is in an inactive state, the sixth node belongs to the base station connected by the fifth node before entering the inactive state, for example, the last serving base station.
Seventh node: it is a user plane portion of the central unit of the base station. This node belongs to the base station serving the fifth node, and the base station may be a base station that is directly connected to the fifth node or a base station that is connected to the user through a relay node, for example, an anchor node. When the fifth node is in an inactive state, the seventh node belongs to the base station connected by the fifth node before entering the inactive state, for example, the last serving base station.
Eighth node: it is a base station, or a central unit of the base station, or a control plane portion of the central unit of the base station. When the fifth node is in an inactive state, this node is different from the base station to which the sixth node and the seventh node belong, and this node is a base station to which the fifth node belongs when in the inactive state, i.e., a base station that services the fifth node currently when the fifth node is in the inactive state. That is, the fifth node is currently within the serving range of the eighth node. For example, this node may be a base station (e.g., a receiving base station) where the fifth node performs small data transmission, and the base station is different from the “last serving base station”. In the actual network, if the user plane and the control plane of one base station are not located in one logic entity, the data transmitted to the user will be transmitted to the user plane portion of the central unit of the base station, but the control of the user needs to be completed by the control plane portion of the central unit of the base station. In order to trigger the user to perform small data transmission or data (non-small data) transmission, an embodiment of the present invention provides a communication method.

The communication method provided in the second aspect of the present invention may be executed by a seventh node, and the communication method may include:
receiving downlink data of a user equipment (UE), the UE is in an active state; and
transmitting a first notification message to a sixth node, the first notification message is used for triggering the UE to start downlink data transmission or terminate small data transmission of the UE.

The downlink data refers to the data that is received by the seventh node and needs to be transmitted to the UE. The downlink data may include at least one of small data and data (normal data/non-small data). Triggering the UE to start downlink data transmission may be triggering the UE to start data transmission, or triggering the UE to start small data transmission. The seventh node may be the user plane portion of the central unit of the base station connected by the UE before entering the inactive state, i.e., the CU-UP of the base station.

In the embodiments of the present invention, for the UE in the inactive state, when there is data (which may be small data or may not be small data) to be transmitted to the UE at the seventh node, the seventh node may transmit the first notification message to the sixth node; or, the seventh node may determine whether to transmit the notification message to the sixth node, and then transmit the first notification message to the sixth node when it is determined to transmit the notification message.

Optionally, the sixth node may configure, for the seventh node, a configuration (the first configuration message hereinafter) related to the transmission of the first notification message, and the seventh node may determine, according to the configuration, when the first notification message needs to be transmitted to the sixth node. Optionally, it is also possible to determine, according to the configuration, what information may be included in the first notification message.

Optionally, upon receiving the first notification message transmitted by the seventh node, the sixth node may determine, according to the message, whether to trigger the UE to start data transmission or start small data transmission or terminate small data transmission (since the UE may be performing small data transmission at this time, the small data transmission may be uplink data transmission or downlink data transmission).

Based on the method provided in the embodiments of the present invention, when the UE is in the inactive state, the network side may trigger the UE to start the transmission of data or small data or terminate the transmission of small data. Optionally, if the UE in the inactive state performs small data transmission, based on the first notification message, the network side triggering the UE to start data transmission may be a process in which the UE terminates small data transmission and then starts data transmission or a process in which the UE directly enters the connected state to perform normal data (non-small data) transmission.

The first notification message may include at least one information used for trigging the UE to start downlink data transmission or terminate small data transmission of the UE. This message is used for assisting the sixth node in determining whether to indicate the UE to start downlink data transmission or indicate the UE to terminate small data transmission. Optionally, if the sixth node determines that the UE terminates small data transmission and if the UE does not perform small data transmission at this time, the sixth node may not transmit indication information to the UE; and if the UE is performing small data transmission, the sixth node may transmit, to the UE, indication information for indicating the UE to terminate small data transmission.

Optionally, the first notification message may include at least one of the following:
information about the downlink data of the UE; information used for requesting or indicating to start the downlink data transmission of the UE; and information used for requesting or indicating to terminate the small data transmission of the UE.

The information about the downlink data of the UE is used for notifying the sixth node of the related information of the downlink data of the UE currently received by the seventh node. Optionally, the information may include, but not limited to, at least one of the following:
first data feature indication information; first data identifier information; and first data volume indication information.

The first data feature indication information is used for indicating the data feature of the downlink data of the UE, and the feature may include, but not limited to, data type (e.g., whether it is small data), data volume, etc.

The second data identifier information is the identifier of the downlink data of the UE, for example, at least one of a DRB identifier, a PDU session identifier, a QoS identifier, etc. The identifier information may inform the sixth node that the seventh node currently has data or small data corresponding to which data identifiers of the UE.

The first data volume indication information is used for indicating the data volume. The representation of the data volume may not be limited in the embodiments of the present invention. For example, the data volume may be represented by the number of data packets, the specific number of bytes of the data, or the range of the data volume. For example, the indication information is an identifier of 1, indicating that the number of data packets of the number of bytes of the data belongs to the range A; and the indication information is an identifier of 2, indicating that the number of data packets or the number of bytes of the data belongs to the range B.

The optional implementations of the first data feature indication information, the first data identifier information and the first data volume indication information may refer to the following related description.

In the embodiments of the present invention, the name of the information used for requesting or indicating to start the downlink data transmission of the UE, the name of the information used for requesting or indicating to terminate the small data transmission of the UE and the specific implementation of the request or indication will not be limited. For example, the information used for requesting or indicating to start the downlink data transmission of the UE may also be the information used for indicating to trigger the UE to start the downlink data transmission of the UE or the information used for assisting the sixth node to determine to start the downlink data transmission of the UE.

Optionally, the information used for requesting or indicating to terminate the small data transmission of the UE includes at least one of the following:
indication information of terminating the small data transmission;
second data identifier information; and
second data volume indication information.

The indication information of terminating the small data transmission is used for directly indicating the sixth node to notify the UE of terminating the small data transmission. The data identifier information or the data volume indication information is used for assisting the sixth node to determine to terminate the small data transmission of the UE.

In one optional embodiment of the present invention, the communication method further includes:

receiving a first configuration message transmitted by the sixth node, the first configuration message includes configuration information related to the data transmission of the UE in the inactive state.

Optionally, the transmitting the first notification message includes: transmitting the first notification message according to the first configuration message.

In this embodiment, the configuration information related to the data transmission of the UE when the UE is in the inactive state may be configured for the seventh node by the sixth node. Optionally, the configuration information related to the data transmission of the UE may include a configuration related to the downlink data transmission of the UE, i.e., configuration information about how the seventh node performs processing upon receiving the downlink data of the UE in the inactive state. According to the configuration, the seventh node may trigger, from the network side, the processing of the data transmission of the UE in the inactive state. Optionally, the seventh node may determine, according to the configuration, whether to transmit the first notification message and some or all of the contents included in this message to the sixth node.

Optionally, the first configuration message may include at least one of the following:
third data identifier information, the identifier information is identifier information of the data related to triggering the transmission of the first notification message;
third data identifier information, and information used for indicating that the downlink data corresponding to the third data identifier information is data or small data; and
data volume threshold indication information, the information is used for indicating the threshold corresponding to the data volume related to triggering the transmission of the first notification message.

The optional implementations of the information included in the first configuration information may refer to the following related description of the first data configuration information.

The communication method provided in the second aspect of the present invention may also be executed by a sixth node, and the method may include:
receiving a first notification message transmitted by a seventh node, the first notification message is used for triggering a UE in an inactive state to start downlink data transmission or terminate small data transmission of the UE; and
in response to the first notification message, transmitting a second notification message to the UE or transmitting a third notification message to an eighth node;
wherein the second notification message is used for indicating the UE to start downlink data transmission or terminate small data transmission, and the third notification message is used for notifying the eighth node of triggering the UE to start downlink data transmission or terminate small data transmission of the UE.

After the sixth node receives the first notification message transmitted by the seventh node, if it is determined to notify the UE of starting the downlink data transmission or terminating the small data transmission of the UE and if the UE is still within the serving range of the sixth node currently, the sixth node may transmit a second notification message to the UE to indicate the UE to perform corresponding processing; and if the UE is not within the serving range of the sixth node currently, the sixth node needs to transmit a corresponding notification message to the eighth node, so that the eighth node indicates or triggers the UE to perform corresponding processing.

There may be one or more eighth nodes.

Optionally, if the UE is performing small data transmission currently, the sixth node may directly transmit a third notification message to an eighth node that services the UE currently. Optionally, if the UE in the inactive state does not perform small data transmission, the sixth node may transmit to a third notification message to each candidate serving cell (eighth node) of the UE, and each eighth node that has received the third notification message may trigger the UE to perform corresponding processing through a system message or in other ways.

The names of the second notification message and the third notification message will not be limited in the present invention and may also be other names. Optionally, the second notification message includes at least one of the following:
information used for indicating the UE to start small data transmission;
information used for indicating the UE to start data transmission;
information used for indicating the UE to terminate small data transmission.

Optionally, the third notification message includes at least one of the following:
information used for indicating the UE to start small data transmission;
information used for indicating the UE to start data transmission;
information used for indicating the UE to terminate small data transmission;
second data feature indication information;
first data identifier information; and
first data volume indication information.

The implementation form of each indication information that may be included in the second notification message and the third notification message will not be limited in the embodiments of the present invention, and the indication information may be an explicit indication or an implicit indication. The optional implementations of the second notification message and the third notification message may refer to the following description of the second notification message and the third notification message.

Optionally, the communication method may further include:
transmitting a first configuration message to the seventh node, the first configuration message includes configuration information related to the data transmission of the UE in the inactive state.

It should be understood that the related contents in the above description of the sixth node and the seventh node as executive bodies may refer to each other.

It can be seen from the above optional embodiments that the communication method provided in the second aspect of the present invention may also be executed by an eighth node. The communication method executed by the eighth node may include:
receiving a third notification message transmitted by a seventh node, the third notification message is used for notifying the eighth node of triggering a UE in an inactive state to start downlink data transmission or terminate small data transmission of the UE; and
transmitting a fourth notification message to the UE, the fourth notification message is used for indicating the UE to start downlink data transmission or terminate small data transmission.

Optionally, the fourth notification message may include at least one of the following:
information used for indicating the UE to start small data transmission; information used for indicating the UE to start data transmission;
information used for indicating the UE to terminate small data transmission; and information used for indicating the UE to terminate small data transmission and start data transmission.

The communication method provided in the second aspect of the present invention may also be executed by a UE. The communication method executed by the UE may include:
receiving a notification message, the notification message is used for indicating the UE to start downlink data transmission or terminate small data transmission, the notification message is a second notification message received from a sixth node or a fourth notification message received from an eighth node; and
in response to the notification message, starting downlink data transmission or terminating small data transmission.

The technical solutions provided in the second aspect of the present invention will be described below by some specific optional embodiments.

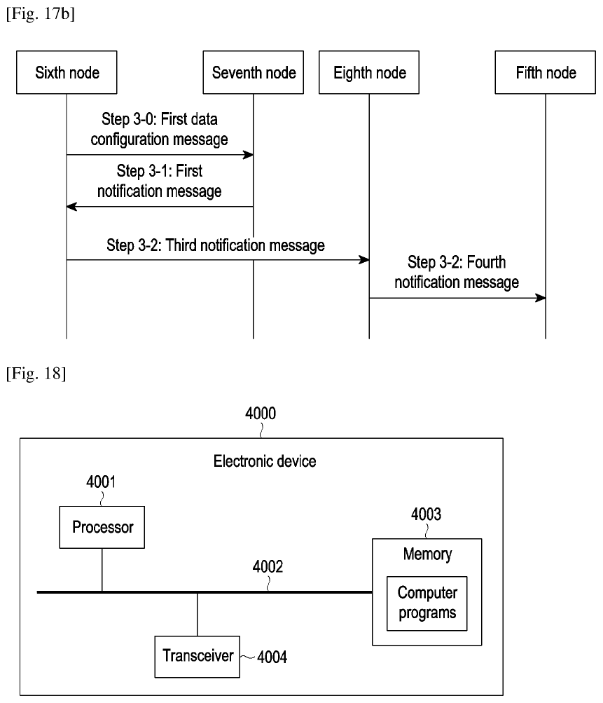

As shown in FIG. 17a, the communication method provided in the second aspect of the present invention may include the following signaling interaction process.

At step 3-1, the seventh node transmits a first notification message to the sixth node. This message is used for notifying information about the data of the fifth node (the downlink data of the fifth node, i.e., the data to be transmitted to the fifth node), thereby assisting the sixth node in determining whether to trigger to the user to perform small data transmission or trigger the user to perform data transmission (e.g., entering the connected state) or trigger the user to stop small data transmission. The first notification message may be transmitted when the fifth node does not start small data transmission, or may be transmitted in the process of performing small data transmission by the fifth node. Upon receiving the first notification message, the sixth node may trigger the fifth node to start small data transmission or trigger the fifth node to terminate or stop small data transmission (e.g., entering the connected state). The message at least includes one of the following information.
First data indication information: the information may also be referred to as first data feature indication information, and the information indicates the configuration information of the data of the user received by the seventh node. Upon receiving the information, the sixth node may know the feature (e.g., whether it is small data, data volume, etc.) of the data of the user, thereby assisting the sixth node in determining whether to trigger the user to perform small data transmission. In one embodiment, the information may be transmitted only when the seventh node receives a data packet belonging to small data. In another embodiment, the information may be transmitted only when the seventh node receives a data packet belonging to small data and a certain condition is satisfied (e.g., the data volume of the small data is less than a certain threshold, or the small data is data corresponding to one or some data identifiers). The information has a technical effect of assisting the sixth node in determining whether to start small data transmission, thereby saving the signaling overhead required for data transmission. The information at least includes one of the following information (indication information of the small data, identifier information of the first data and indication information of the data volume).
Indication information of the small data: the information indicates that the seventh node has received the data packet of the small data of the fifth node. The information has a technical effect of assisting the sixth node in knowing the arrival of the small data of the fifth node, so that the sixth node can start the process of small data transmission and the signaling overhead is saved. In one embodiment, the information is transmitted when the seventh node has received small data belonging to the fifth node. In another embodiment, the information is transmitted when the seventh node has received small data belonging to the fifth node and the number of the received small data is less than a threshold (the threshold may be preconfigured for the seventh node by the sixth node or configured by OAM, or may be predetermined through a protocol). In another embodiment, the information is transmitted when the seventh node has received small data of different services (e.g., radio bearers, QoS flows, PDU sessions) belonging to the fifth node and the number or data volume of small data of each service (or some services) is less than the corresponding threshold (the threshold may be specific to different services, that is, different services has the same or different thresholds, or all services use the same threshold; and the threshold may be preconfigured by the sixth node or configured by OAM, or may be predetermined through a protocol). In one implementation, only the data newly received by the seventh node (e.g., the data that has been received by the seventh node but not yet transmitted to the fifth node) may be taken into consideration during the calculation of the number or data volume. In one implementation, all data packets received by the seventh node when transmitting the first notification message or all data packets belonging to the small data may be taken into consideration during the calculation of the number or data volume (optionally, the packets cached at the seventh node may be included, or the data packets already transmitted to the fifth node during the small data transmission of the fifth node may also be included, or all data packets of the fifth node stored at the seventh node may be included).
Identifier information of the first data: it may also be referred to as first data identifier information. The information may be identifier information of radio bearers (e.g., identifier information of data radio bearers (DRBs)), identifier information of QoS flows, or identifier information of PDU sessions. In one embodiment, the data indicated by the information belongs to small data, that is, the information is transmitted only when the arrived data packets are data packets belonging to small data. In another embodiment, the information is transmitted when the seventh node has received small data belonging to the fifth node and the number of the received small data is less than a threshold (the threshold may be preconfigured by the sixth node or configured by OAM, for example, the “second threshold information” in the “first data configuration message” described below, and the threshold may also be predetermined through a protocol). In another embodiment, the information is transmitted when the seventh node has received small data of different services (e.g., radio bearers, QoS flows, PDU sessions) belonging to the fifth node and the number of small data of each service (or some service) is less than the corresponding threshold (the threshold may be specific to different services, that is, different services has the same or different thresholds, or all services use the same threshold; and the threshold may be preconfigured by the sixth node or configured by OAM, for example, the “first threshold information” in the “first data configuration message” described below). In one implementation, only the data newly received by the seventh node may be taken into consideration during the calculation of the data volume. In one implementation, all data packets received by the seventh node when transmitting the first notification message or all data packets belonging to the small data may be taken into consideration during the calculation of the number (the packets cached at the seventh node are included, and the data packets already transmitted to the fifth node during the small data transmission of the fifth node are also included). The information has a technical effect of assisting the sixth node in knowing whether the data of the seventh node is small data, so that the sixth node can start the process of small data transmission and the signaling overhead is saved.
Indication information of the data volume (first data volume indication information): the information indicates the number of data packets belonging to the fifth node received by the seventh node, for example, the number of packets, the size of data packets (the unit may be bit, byte, etc.), etc. In one implementation, only the data newly received by the seventh node may be taken into consideration during the calculation of the data volume. In one implementation, all data packets received by the seventh node when transmitting the first notification message or all data packets belonging to the small data may be taken into consideration during the calculation of the data volume (the packets cached at the seventh node are included, and the data packets already transmitted to the fifth node during the small data transmission of the fifth node are also included). The data volume indication information may be given for different data identified by the “identifier information of the data”, or may indicate the total number of data packets received by the seventh node. In one embodiment, the information is transmitted only when the arrived data packets are data packets belong to the small data. In another embodiment, the information is transmitted when the seventh node has received small data belonging to the fifth node and the number of the received small data is less than a threshold (the threshold may be preconfigured by the sixth node or configured by OAM, for example, the “second threshold information” in the “first data configuration message” described below). In another embodiment, the information is transmitted when the seventh node has received small data of different services (e.g., radio bearers, QoS flows, PDU sessions) belonging to the fifth ode and the number of small data of each service (or some services) is less than the corresponding threshold (the threshold may be specific to different services, that is, different services have the same or different thresholds, or all services use the same threshold; and the threshold may be preconfigured by the sixth node or configured by OAM, for example, the “first threshold information” in the “first data configuration message” described below). The information has a technical effect of assisting the sixth node in knowing the volume of data that arrives the seventh node, so that the sixth node determines whether the process of small data transmission may be started, thereby avoiding the unnecessary signaling overhead.
First request information (information used for requesting or indicating to start downlink data transmission of the UE): the information is used for requesting the sixth node to trigger the user to perform small data transmission. For example, the information may be request to resume small data transmission. In one embodiment, the information is transmitted only when the arrived data packets are data packets belong to the small data. In another embodiment, the information is transmitted when the seventh node has received small data belonging to the fifth node and the number of the received small data is less than a threshold (the threshold may be preconfigured by the sixth node or configured by OAM, for example, the “second threshold information” in the “first data configuration message” described below). In another embodiment, the information is transmitted when the seventh node has received small data of different services (e.g., radio bearers, QoS flows, PDU sessions) belonging to the fifth node and the number or data volume of small data of each service (or some services) is less than the corresponding threshold (the threshold may be specific to different services, that is, different services have the same or different thresholds, or all services use the same threshold; and the threshold may be preconfigured by the sixth node or configured by OAM, for example, the “second threshold information” in the “first data configuration message” described below). In one implementation, only the data newly received by the seventh node may be taken into consideration during the calculation of the number or data volume. In one implementation, all data packets received by the seventh node when transmitting the first notification message or all data packets belonging to the small data may be taken into consideration during the calculation of the number or data volume (the packets cached at the seventh node are included, and the data packets already transmitted to the fifth node during the small data transmission of the fifth node are also included). The information has a technical effect of assisting the sixth node in starting the process of small data transmission, thereby saving the signaling overhead.
Second request information (information used for requesting or indicating to terminate small data transmission of the UE): the information requests the sixth node to terminate the small data transmission performed by the fifth node. The request information may be transmitted since the seventh node has received data packets of small data that does not belong to the fifth node, or may be transmitted since the data volume of small data belonging to the fifth node received by the seventh node exceeds a certain threshold. The information has a technical effect of assisting the sixth node in terminating small data transmission, thereby improving the performance (e.g., rate, delay, etc.) of data transmission. The information at least includes one of the following information.
Second indication information (indication information for terminating small data transmission): the information is indicative of terminating the small data transmission of the fifth node. That is, if the fifth node is performing small data transmission, the information is used for indicating or notifying the sixth node to terminate the small data transmission of the fifth node.
Identifier information of the second data (second data identifier information): the information may be identifier information of radio bearers (e.g., data radio bearers (DRBs)), identifier information of QoS flows, or identifier information of PDU sessions. In one embodiment, the data indicated by the information belongs to small data. In another embodiment, the data indicated by the information does not belong to small data. In one implementation, if the identifier information is an identifier of a PDU session or an identifier of a QoS flow, after the sixth node receives the information, no matter whether the data indicated by the identifier is small data, the sixth node needs to terminate the small data transmission of the fifth node, that is, the sixth node needs to trigger the fifth node to enter the connected state for data transmission. In another implementation, if the identifier information is an identifier of a PDU session, an identifier of a QoS flow or a DRB identifier and the data corresponding to the identifier of the PDU session, the identifier of the QoS flow or the DRB identifier is small data, after the sixth node receive the information, the sixth node needs to terminate the small data transmission of the fifth node, that is, the sixth node needs to trigger the fifth node to enter the connected state for data transmission.
Indication information of the second data volume (second data volume indication information): the information indicates the number of data volume of the data packets belonging to the fifth node received by the seventh node, for example, the number of packets, the size of data packets (the unit may be bit, byte, etc.), etc. In one implementation, only the data newly received by the seventh node may be taken into consideration during the calculation of the data size or data volume. In one implementation, all data packets received by the seventh node when transmitting the first notification message or all data packets belonging to the small data may be taken into consideration during the calculation of the data size or data volume (the packets cached at the seventh node are included, and the data packets already transmitted to the fifth node during the small data transmission of the fifth node are also included). The data volume indication information may be given for different data identified by the “identifier information of the second data”, and may also indicate the total number of data packets received by the seventh node. In one embodiment, the information is transmitted only when the arrived data packets are data packets belong to the small data. In another embodiment, the information is transmitted when the seventh node has received small data belonging to the fifth node and the number of the received small data is greater than a threshold (the threshold may be preconfigured by the sixth node or configured by OAM, for example, the “fourth threshold information” in the “first data configuration message” described below). In another embodiment, the information is transmitted when the seventh node has received small data of different services (e.g., radio bearers, QoS flows, PDU sessions) belonging to the fifth node and the number of small data of each service (or some services) is greater than the corresponding threshold (the threshold may be specific to different services, that is, different services have the same or different thresholds, or all services use the same threshold; and the threshold may be preconfigured by the sixth node or configured by OAM, for example, the “third threshold information” in the “first data configuration message” described below).

After the sixth node has received the first notification message, the achieved technical effect is that it can be determined whether to start small data transmission of the fifth node or start data transmission (entering the connected state for data transmission) or whether to terminate small data transmission of the fifth node, thereby avoiding the signaling overhead and the performance reduction of data transmission. Optionally, the sixth node may determine, according to the type of the data received by the seventh node (e.g., whether it belongs to small data) or the data volume of the received data (whether the data volume is less than a certain threshold), whether to trigger the fifth node to perform small data transmission or data transmission or whether to terminate small data transmission of the fifth node.

The step 3-1 has the beneficial effect of informing the sixth node of the arrival of user data, thereby assisting the sixth node in determining whether to start small data transmission and reducing the unnecessary signaling overhead.

If the sixth node determines to trigger the fifth node to perform small data transmission or terminate small data transmission of the fifth node, the communication method further includes the following steps.

At step 3-2, optionally, the sixth node transmits a second notification message to the fifth node. This message is used for notifying the fifth node of starting the process of small data transmission or stopping small data transmission or starting data transmission (e, g., entering the connected state so as to start the transmission of all data). This message at least includes one of the following information.
First small data indication information (information used for indicating the UE to start small data transmission): the information indicates that the small data of the fifth node needs to be transmitted, for example, SDT indication, mobile terminated SDT indication. The information has a technical effect of assisting the fifth node in starting small data transmission, thereby reducing the signaling overhead. Upon receiving the indication information, the fifth node may start the process required for small data transmission. In one embodiment, if the user is in the inactive state (RRC Inactive) and has received the indication information, the user starts the RRC resume process, and this process is used for starting the process required for small data transmission.
First start indication information (information used for indicating the UE to start small data transmission): the information is indicative of starting the small data transmission of the fifth node. Upon receiving the indication information, the fifth node may start the process required for small data transmission. The information has a technical effect of assisting the fifth node in starting small data transmission, thereby reducing the signaling overhead. In one embodiment, if the user is in the inactive state (RRC Inactive) and has received the indication information, the user starts the RRC resume process, and this process is used for starting the process required for small data transmission.
Second start indication information (information used for indicating the UE to start data transmission): the information indicates the process of starting data transmission by the user. Upon receiving the information, the “starting data transmission” has the following possible implementations: 1) implementation 1: if the fifth node is performing small data transmission, the user directly starts other non-small data transmissions without performing a connection resume process, that is, the UE may directly enter the connected state from the inactive state; 2) implementation 2: if the fifth node is performing small data transmission, the user stops the small data transmission, starts a connection resume process, enters the connected state and performs data transmission; and 3) implementation 3: if the fifth node does not perform data transmission, for example, being in the inactive state or idle state, the fifth node starts a connection resume process, enters the connected state and performs data transmission. The information has a technical effect of assisting the fifth node in starting data transmission, thereby improving the performance of data transmission.
First stop indication information (information used for indicating the UE to terminate small data transmission): the information is indicative of stopping small data transmission of the fifth node if the fifth node is performing small data transmission. In one embodiment, the indication information may be an explicit indication, that is, the information may be a representation indicative of stopping or terminating small data transmission. In another embodiment, the information may be implicitly indicated by the type of the second notification message. For example, when the second notification message is an RRC release message, it indicates that the fifth node needs to stop small data transmission, so that the user enters the idle state or the inactive state. The information has a technical effect of assisting the fifth node in stopping data transmission, thereby reducing the signaling overhead and the energy consumption.

The step 3-2 has the beneficial effect of configuring the fifth node to perform data transmission, thereby avoiding the unnecessary signaling overhead.

In order to trigger the seventh node to transmit the first notification message, before the step 3-1, optionally, the sixth node may configure the seventh node, so that the seventh node transmits the content in the first notification message according to the configuration. The configuration may be realized by the following steps.

At step 3-0, the sixth node transmits a first data configuration message (first configuration message) to the seventh node. This message is a notification for indicating the seventh node to perform related processing after receiving the small data or data of the fifth node. This message at least includes one of the following information.
Third data identifier information: the information may be identifier information of radio bearers (e.g., identifier information of data radio bearers (DRBs)), identifier information of QoS flows, or identifier information of PDU sessions. The information is used for notifying the seventh node that it needs to transmit the first notification message to the sixth node after receiving the data corresponding to which identifiers of the UE, or notifying the seventh node that it may need to transmit the data to the sixth node after receiving the data corresponding to which identifiers of the UE. For example, when the seventh node receives the data corresponding to the third data identifier information, the seventh node need to transmit the first notification message if the data volume satisfies a certain threshold.
Second data indication information: the information indicates whether the data indicated by the “third data identifier information” is the small data of the fifth node, that is, the information is information used for indicating that the downlink data of the third data identifier information is data or small data. The information has a technical effect of assisting the seventh node in determining the small data so as to detect the arrival of the small data and providing assistant information (the first notification message) to the seventh node to assist in determining whether to start small data transmission, thereby avoiding the unnecessary signaling overhead at the fifth node.
First threshold information (data volume threshold indication information): the information indicates the threshold information used when the seventh node informs the sixth node of the arrival of the small data or data of the fifth node. The threshold information may be given for the data indicated by the “third data identifier information”. In one embodiment, when the data volume of the data indicated by the “third data identifier information” received by the seventh node is less than the threshold, the seventh node will inform the sixth node by the step 3-1. The information has a technical effect of assisting the seventh node in determining whether to start small data transmission, thereby reducing the unnecessary signaling overhead.
Second threshold information (data volume threshold indication information): the information indicates the threshold information used when the seventh node informs the sixth node of the arrival of the small data or data of the fifth node. The threshold information indicates a threshold of the total volume of small data of the fifth node received by the seventh node. In one embodiment, when the data volume of the data indicated by all the “third data identifier information” received by the seventh node is less than the threshold (for example, the number of all small data received by the seventh node is less than the threshold), the seventh node will inform the sixth node by the step 3-1. The information has a technical effect of assisting the seventh node in determining whether to start small data transmission, thereby reducing the unnecessary signaling overhead.
Third threshold information (data volume threshold indication information): the information indicates the threshold information used when the seventh node informs the sixth node of the arrival of the small data or data of the fifth node. The threshold information may be given for the data indicated by the “third data identifier information”. In one embodiment, when the data volume of the data indicated by the “third data identifier information” received by the seventh node is greater than the threshold, the seventh node will inform the sixth node by the step 3-1. The information has a technical effect of assisting the seventh node in determining whether to start data transmission, thereby ensuring the performance of data transmission.
Fourth threshold information (data volume threshold indication information): the information indicates the threshold information used when the seventh node informs the sixth node of the arrival of the small data or data (non-small data) of the fifth node. The threshold information indicates a threshold of the total volume of the small data or data of the fifth node received by the seventh node. In one embodiment, when the data volume of the data indicated by all the “third data identifier information” received by the seventh node is greater than the threshold (that is, the number of all small data received by the seventh node is greater than the threshold), the seventh node will inform the sixth node by the step 3-1. The information has a technical effect of assisting the seventh node in determining whether to start data transmission, thereby ensuring the performance of data transmission.

The step 3-0 has the beneficial effect of configuring the seventh node to detect the arrival of data, thereby assisting the sixth node in determining whether to start small data transmission and avoiding the unnecessary signaling overhead.

If the fifth node is not within the serving range of the sixth node, for example, entering the serving range the eighth node, after the step 3-1, the following step may also be included, as shown in FIG. 17b.

At step 3-2a, the sixth node transmits a third notification message to the eighth node. This message is used for notifying the eighth node of triggering the fifth node to perform small data transmission or stop small data transmission or start data transmission (e.g., entering the connected state so as to start the transmission of all data). This message at least includes one of the following information.
First message container (information used for indicating the UE to start small data transmission or information used for indicating the UE to start small data transmission): the container includes a first message (e.g., a paging message) transmitted to the fifth node. In one embodiment, the information included in the message in this container may be used for indicating the fifth node to start small data transmission. In another embodiment, the information included in the message in this container may be used for indicating the fifth node to start data transmission (the “starting data transmission” has the following possible implementations: 1) implementation 1: if the fifth node is performing small data transmission, the user directly starts other non-small data transmissions without performing a connection resume process; 2) implementation 2: if the fifth node is performing small data transmission, the user stops the small data transmission, starts a connection resume process, enters the connected state and performs data transmission; and 3) implementation 3: if the fifth node does not perform data transmission, for example, being in the inactive state or idle state, the fifth node starts a connection resume process, enters the connected state and performs data transmission). The specific content of the message in this container may refer to the content in the second notification message, for example, the first small data indication information, the first start indication information, the second start indication information, etc. The container has a technical effect of assisting the eighth node to notify the fifth node to perform data transmission, thereby reducing the signaling overhead and ensuring the performance of data transmission.
Second message container (information used for indicating the UE to terminating small data transmission or information used for indicating the UE to start data transmission): the container includes a second message transmitted to the fifth node, for example, an RRC release message. The information included in the message in the container may be used for indicating the fifth node to stop small data transmission, or indicating the fifth node to stop small data transmission and start data transmission. The specific content of the message in the container may refer to the content in the second notification information, for example, the second start indication information, the first stop indication information, etc. The container has a technical effect of assisting the eighth node in notifying the fifth node of stopping the ongoing data transmission or starting new data transmission, thereby reducing the signaling overhead and ensuring the performance of data transmission.
Second small data indication information (information used for indicating the UE to start small data or data transmission): the specific description may refer to the “first small data indication information”.
Third start indication information (information used for indicating the UE to start small data or data transmission): the specific description may refer to the “first start indication information”.
Fourth start indication information (information used for indicating the UE to start small data or data transmission): the specific description may refer to the “second start indication information”.
Second stop indication information (information used for indicating the UE to terminate small data transmission): the specific description may refer to the “first stop indication information”.

The step 3-2a has the beneficial effect of informing the eighth node of the state of the arrival of data of the fifth node and notifying the fifth node of performing signaling interaction, thereby avoiding the unnecessary signaling overhead. Upon receiving the first notification message transmitted by the seventh node, the sixth node may determine the information included in the third notification message according to the information included in the first notification message. Optionally, the seventh node may determine, according to the first data configuration message transmitted by the sixth node or the predetermination through a protocol, when the first notification message needs to be transmitted to the sixth node. Optionally, the content in the transmitted first notification message may also be determined.

Further, optionally, the communication method further includes a step 3-2b: transmitting, by the eighth node, a fourth notification message to the fifth node. This message is used for notifying the fifth node of starting the process of small data transmission or stopping small data transmission or starting data transmission (e.g., entering the connected state so as to start the transmission of all data). Optionally, the message at least includes one of the following information.
Third small data indication information: the specific description may refer to the “first small data indication information”.
Fifth start indication information: the specific description may refer to the “first start indication information”.
Sixth start indication information: the specific description may refer to the “second start indication information”.
Third stop indication information: the specific description may refer to the “first stop indication information”.

Optionally, the “third notification message” may contain both the “first message container” and the “second message container”. At the step 3-2b, upon receiving the third notification message transmitted by the sixth node, the eighth node may transmit the RRC release message in the second message container to the fifth node and then transmit the paging message in the first message container to the fifth node. Thus, the fifth node may enter the inactive or idle state first, then starts the connection resume or establishment process and performs small data transmission or data transmission.

The step 3-2b has the beneficial effect of configuring the fifth node to perform data transmission, thereby avoiding the unnecessary signaling overhead.

After the step 3-2 or 3-2b, if the fifth node determines that the network side requires it to perform small data transmission, the fifth node initiates the process of small data transmission. For example, the fifth node may transmit signaling and/or data on a resource configured for the small data transmission, for example, transmitting a random access signal on the uplink resource configured for the small data transmission, transmitting a connection resume request message on the resource configured for the small data transmission, or transmitting a small data packet on the uplink resource configured for the small data transmission. After the fifth node accesses the network, the fifth node further performs small data reception or transmission. If the fifth node that it is required to stop small data transmission, the fifth node stops small data transmission and enters the inactive state or idle state. If the fifth node determines that it is required to start data transmission, there are the following possible implementations: 1) implementation 1: if the fifth node is performing small data transmission, the user directly starts other non-small data transmissions without performing the connection resume process; 2) implementation 2: if the fifth node is performing small data transmission, the user stops small data transmission, starts the connection resume process, enters the connected state and performs data transmission; and 3) implementation 3: if the fifth node does not perform data transmission, for example, being in the inactive state or idle state, the fifth node starts the connection resume process, enters the connected state and performs data transmission.

It is to be noted that the names of the notification messages, information and other terms described in the optional embodiments provided in the second aspect of the present invention are schematic names and may also use other names. The content indicated/notified/requested by each message or information may be explicit indication/notification/request information or implicit indication/notification/request information. In the above process, optionally, the first notification message may be a Bearer Context Modification Required message or a DL Data Notification message on the E1 interface, or may be other existing messages on the E1 interface, or may be a newly defined message.

Optionally, the second notification message or the fourth notification message may be a paging message or an RRC Release message on the air interface, or may be the existing RRC message, or may be a newly defined message.

Optionally, the third notification message may be an RAN Paging message, a UE Context Release message, a Partial UE Context Transfer Failure message or a Retrieve UE Context Failure message on the Xn interface, or may be other existing messages on the Xn interface, or may be a newly defined message.

Optionally, the first data configuration message a Bearer Context Setup Request message or a Bearer Context Modification Request message on the E1 interface, or may be other messages on the E1 interface, or may be a newly defined message.

Corresponding to the communication method provided in the second aspect of the present invention, the present invention further provides a network node. The network node may include:
at least one transceiver; and
at least one processor, wherein the at least one processor is coupled to the transceiver and configured to implement the method executed by a sixth node or the method executed by a seventh node or the method executed by an eighth node provided in the embodiments of the present invention.

The present invention further provides a user equipment. The user equipment includes:
at least one transceiver; and
at least one processor, wherein the at least one processor is coupled to the transceiver and configured to implement the method by a UE provided in the embodiments of the present invention.

An embodiment of the present invention provides an electronic device, including a memory, a processor and computer programs stored on the memory, wherein the processor executes the computer programs to implement the steps in the method according to any one of the optional embodiments of the present invention.

FIG. 18 shows a schematic structure diagram of an electronic device to which an embodiment of the present invention is applicable. As shown in FIG. 18, the electronic device 4000 in FIG. 18 includes a processor 4001 and a memory 4003. The processor 4001 is connected to the memory 4003, for example, via a bus 4002. Optionally, the electronic device 4000 may further include a transceiver 4004. The transceiver 4004 may be configured for data interaction between the electronic device and other electronic devices, for example, transmitting data and/or receiving data, etc. It is to be noted that, in practical applications, the number of the transceiver 4004 is not limited to one, and the structure of the electronic device 4000 does not constitute any limitation to the embodiments of the present application. Optionally, the electronic device may be a first network node, a second network node, a third network node, a sixth network node, a seventh network node, an eighth network node or a UE.

The processor 4001 may be a central processing unit (CPU), a general-purpose processor, a digital signal processor (DSP), an application specific integrated circuit (ASIC), a field programmable gate array (FPGA) or other programmable logic devices, a transistor logic device, a hardware component or any combination thereof. The processor can implement or execute various exemplary logic blocks, modules and circuits described in the disclosure of the present invention. The processor 4001 may also be a combination for realizing computing functions, for example, a combination of one or more microprocessors, a combination of DSPs and microprocessors, etc.

The bus 4002 may include a passageway for transferring information between the above components. The bus 4002 may be a peripheral component interconnect (PCI) bus, an extended industry standard architecture (EISA) bus, etc. The bus 4002 may be classified into address bus, data bus, control bus, etc. For ease of representation, the bus is represented by only one bold line in FIG. 18, but it does not mean that there is only one bus or one type of buses.

The memory 4003 may be, but not limited to, read only memories (ROMs) or other types of static storage devices capable of storing static information and instructions, random access memories (RAMs) or other types of dynamic storage devices capable of storing information and instructions, or electrically erasable programmable read only memories (EEPROMs), compact disc read only memories (CD-ROMs) or other optical disc storages, optical disc storages (including compact discs, laser discs, optical discs, digital versatile optical discs, Blue-ray discs, etc.), magnetic disc storage mediums or other magnetic storage devices, or any other medium that can be used to carry or store computer programs and can be accessed by a computer.

The memory 4003 is configured to store compute programs for executing the embodiments of the present invention, and is controlled and executed by the processor 4001. The processor 4001 is configured to execute the computer programs stored in the memory 4003 to implement the steps in the above method embodiments.

An embodiment of the present invention provides a computer-readable storage medium storing computer programs that, when executed by a processor, can implement the steps and corresponding contents in the above method embodiments.

An embodiment of the present invention further provides a computer program product, including computer programs that, when executed by a processor, can implement the steps and corresponding contents in the above method embodiments.

The terms “first”, “second”, “third”, “fourth”, “1”, “2”, etc. (if any) in the specification and claims of the present invention and the accompanying drawings are used for distinguishing similar objects, rather than describing a particular order or precedence. It should be understood that the used data can be interchanged if appropriate, so that the embodiments of the present invention described herein can be implemented in an order other than the orders illustrated or described with text.

It should be understood that, although the operation steps are indicated by arrows in the flowcharts of the embodiments of the present invention, the implementation order of these steps is not limited to the order indicated by the arrows. Unless otherwise explicitly stated herein, in some implementation scenarios of the embodiments of the present invention, the implementation steps in the flowcharts may be executed in other orders as required. In addition, depending on practical implementation scenarios, some or all of the steps in the flowcharts may include a plurality of sub-steps or a plurality of stages. Some or all of these sub-steps or stages may be executed at the same moment, and each of these sub-steps or stages may be separately executed at a different moment. When each of these sub-steps or stages is executed at a different moment, the execution order of these sub-steps or stages may be flexibly configured as required, and will not be limited in the embodiments of the present invention.

The above-mentioned description is merely an alternative embodiment for some implementation scenarios of the present application, and it should be noted that it would have been within the scope of protection of embodiments of the present application for those skilled in the art to adopt other similar implementation means based on the technical idea of the present application without departing from the technical concept of the solution of the present application.

1.-15. (canceled)

16. A method for communication by a central unit-control plane (CU-CP) of a base station in a wireless communication system, the method comprising:
transmitting, to a central unit-user plane (CU-UP) of the base station, a configuration message including information indicating a threshold of a small data transmission (SDT) data size;
receiving, from the CU-UP of the base station, a notification message including information related to SDT, based on the configuration message; and
transmitting, to a user equipment (UE), a paging message including a mobile terminated-SDT (MT-SDT) indicator for initiating an SDT procedure of the UE, based on the notification message.

17. The method of claim 16, wherein the information related to SDT comprises information related to MT-SDT indicating a total data size for all SDT bearers.

18. The method of claim 16, wherein the information related to SDT comprises information for terminating the SDT procedure of the UE, in case that a size of SDT data received at the CU-UP is above the threshold of the SDT data size.

19. The method of claim 18, further comprising:
in case that the notification message includes the information for terminating the SDT procedure of the UE, terminating the SDT procedure of the UE.

20. An electronic device for a central unit-control plane (CU-CP) of a base station in a wireless communication system, the electronic device comprising:
a transceiver; and
at least one processor coupled to the transceiver,
wherein the at least one processor is configured to:
transmit, to a central unit-user plane (CU-UP) of the base station, a configuration message including information indicating a threshold of a small data transmission (SDT) data size;
receive, from the CU-UP of the base station, a notification message including information related to SDT, based on the configuration message; and
transmit, to a user equipment (UE), a paging message including a mobile terminated-SDT (MT-SDT) indicator for initiating an SDT procedure of the UE, based on the notification message.

21. The electronic device of claim 20, wherein the information related to SDT comprises information related to MT-SDT indicating a total data size for all SDT bearers.

22. The electronic device of claim 20, wherein the information related to SDT comprises information for terminating the SDT procedure of the UE, in case that a size of SDT data received at the CU-UP is above the threshold of the SDT data size.

23. The electronic device of claim 20, wherein the at least one processor is configured to:
in case that the notification message includes the information for terminating the SDT procedure of the UE, terminate the SDT procedure of the UE.

24. A non-transitory computer-readable storage medium storing computer programs which, when executed by at least one processor of an electronic device for a central unit-control plane (CU-CP) of a base station, cause the CU-CP to perform operations comprising:
transmitting, to a central unit-user plane (CU-UP) of the base station, a configuration message including information indicating a threshold of a small data transmission (SDT) data size;
receiving, from the CU-UP of the base station, a notification message including information related to SDT, based on the configuration message; and
transmitting, to a user equipment (UE), a paging message including a mobile terminated-SDT (MT-SDT) indicator for initiating an SDT procedure of the UE, based on the notification message.

25. The non-transitory computer-readable storage medium of claim 24, wherein the information related to SDT comprises information related to MT-SDT indicating a total data size for all SDT bearers.

26. The non-transitory computer-readable storage medium of claim 24, wherein the information related to SDT comprises information for terminating the SDT procedure of the UE, in case that a size of SDT data received at the CU-UP is above the threshold of the SDT data size.

27. The non-transitory computer-readable storage medium of claim 26, wherein the operations further comprises:
in case that the notification message includes the information for terminating the SDT procedure of the UE, terminating the SDT procedure of the UE.
